(19) United States
(12) Patent Application Publication
(10) Pub. No.: US 2025/0182122 A1
(43) Pub. Date: Jun. 5, 2025

(54) FRAUD DETECTION APPARATUS, FRAUD DETECTION SYSTEM, AND FRAUD DETECTION METHOD

(71) Applicant: TOSHIBA TEC KABUSHIKI KAISHA, Tokyo (JP)

(72) Inventors: Tomonari Kakino, Fuji Shizuoka (JP); Keita Yamazaki, Mishima Shizuoka (JP); Yuishi Takeno, Numazu Shizuoka (JP); Yusuke Mimura, Sunto Shizuoka (JP)

(21) Appl. No.: 18/761,352

(22) Filed: Jul. 2, 2024

(30) Foreign Application Priority Data
Dec. 1, 2023 (JP) 2023-204076

(51) Int. Cl. G06Q 20/40

(52) U.S. Cl. CPC G06Q 20/4016

(57) ABSTRACT

A fraud detection apparatus includes a person detecting unit, a commodity detecting unit, and a fraud alerting unit. The person detecting unit detects, based on an image capturing a target apparatus that is a fraud detection target, a person in a first area in the periphery of the target apparatus. The commodity detecting unit detects, based on the image, at least one of a commodity and a storing body storing the commodity in a second area in the periphery of the target apparatus. The fraud alerting unit alerts a store clerk to a fraud if the person detecting unit does not detect the person and the commodity detecting unit does not detect both of the commodity and the storing body in a state in which settlement processing is executed for the commodity.

### CROSS-REFERENCE TO RELATED APPLICATION

This application is based upon and claims the benefit of priority from Japanese Patent Application No. 2023-204076, filed on Dec. 1, 2023, the entire contents of which are incorporated herein by reference.

### FIELD

Embodiments described herein relate generally to a fraud detection apparatus, a fraud detection system, and a fraud detection method.

### BACKGROUND

JP-A-2016-110559 (Patent Literature 1) discloses a technique of suppressing a fraudulent act of taking out a registered commodity to the outside of a store without settling an account in a POS system separately including a registration apparatus and a settlement apparatus. This is a technique of imaging a registering customer at the time of registration in the registration apparatus and alerting a store clerk if the registering customer is absent in an image captured on the settlement apparatus side.

The POS system disclosed in Patent Literature 1 is based on the premise that the registering customer who performed the registration in the registration apparatus and a settling customer who performs settlement in the settlement apparatus are the same person. This requires a high-performance processing apparatus for performing processing requiring a high person recognition ability such as identity determination by feature value detection and feature value comparison for persons. The imaging of the settling customer on the settlement apparatus side is not always performed at the same imaging angle as the imaging of the registering customer on the registration apparatus side and identity misrecognition occurs.

### BRIEF DESCRIPTION OF THE DRAWINGS

FIG. 1 is a diagram illustrating a disposition form example of a semi-self-service checkout system in a store to which a fraud detection system according to a first embodiment is applied;

FIG. 2 is a block configuration diagram of the semi-self-service checkout system;

FIG. 3 is a block diagram illustrating a main part configuration of a settlement apparatus to which a fraud detection apparatus according to the first embodiment is applied;

FIG. 4 is a perspective view illustrating the exterior of the settlement apparatus;

FIG. 5 is a schematic diagram for explaining a situation in which a processor of the settlement apparatus determines that a fraud is absent;

FIG. 6 is a schematic diagram for explaining a situation in which the processor determines that a fraud is absent;

FIG. 7 is a schematic diagram for explaining a situation in which the processor determines that a fraud is present;

FIG. 8 is a flowchart illustrating a main part procedure of information processing relating to settlement executed by the processor;

FIG. 9 is a flowchart illustrating a main part procedure of fraud detection processing executed by the processor;

FIG. 10 is a schematic diagram for explaining a detection area in a captured image;

FIG. 11 is a schematic diagram for explaining the detection area in the captured image;

FIG. 12 is a schematic diagram for explaining 0° of the direction of a customer in the captured image;

FIG. 13 is a schematic diagram for explaining a range in which it is determined that the customer is facing the settlement apparatus;

FIG. 14 is a flowchart illustrating a main part procedure of fraud detection processing executed by a processor of a settlement apparatus to which a fraud detection apparatus according to a second embodiment is applied;

FIG. 15 is a flowchart illustrating a main part procedure of a touch panel input detection subroutine in FIG. 14;

FIG. 16 is a perspective view illustrating the exterior of a self-service POS terminal to which a fraud detection apparatus according to a third embodiment is applied;

FIG. 17 is a block diagram illustrating a main part configuration of the self-service POS terminal;

FIG. 18 is a flowchart illustrating a main part procedure of information processing executed by a processor of the self-service POS terminal;

FIG. 19 is a block configuration diagram of a semi-self-service checkout system to which a fraud detection system including a fraud detection apparatus according to a fourth embodiment is applied;

FIG. 20 is a block diagram illustrating a main part configuration of a server apparatus to which the fraud detection apparatus according to the fourth embodiment is applied;

FIG. 21 is a diagram illustrating a data configuration of a flag table included in the server apparatus;

FIG. 22 is a diagram illustrating a data configuration of an equipment setting table included in the server apparatus;

FIG. 23 is a sequence chart illustrating an operation overview of the fraud detection system;

FIG. 24 is a sequence chart illustrating an operation overview of the fraud detection system;

FIG. 25 is a flowchart illustrating a main part procedure of information processing relating to settlement executed by a processor of the server apparatus;

FIG. 26 is a flowchart illustrating a main part procedure of fraud detection processing executed by the processor;

FIG. 27 is a block configuration diagram of a fraud detection system including a fraud detection apparatus according to a fifth embodiment; and

FIG. 28 is a schematic diagram for explaining a detection area in a captured image.

### DETAILED DESCRIPTION

Accordingly, the POS system disclosed in Patent Literature 1 has a problem in that a fraudulent act cannot be inexpensively and accurately detected. An aspect of embodiments is to provide a fraud detection apparatus, a fraud detection system, and a fraud detection method that make it possible to inexpensively and accurately detect a fraudulent act of taking out a registered commodity to the outside of a store without settling an account.

In one embodiment, a fraud detection apparatus includes a person detecting unit, a commodity detecting unit, and a fraud alerting unit. The person detecting unit detects, based on an image capturing a target apparatus that is a fraud detection target, a person in a first area in a periphery of the target apparatus. The commodity detecting unit detects, based on the image, at least one of a commodity and a storing body storing the commodity in a second area in the periphery of the target apparatus. The fraud alerting unit alerts a store clerk to a fraud if the person detecting unit does not detect the person and the commodity detecting unit does not detect both of the commodity and the storing body in a state in which settlement processing is executed for the commodity.

Embodiments are explained below with reference to the drawings.

### First Embodiment

A fraud detection system according to a first embodiment corresponds to a semi-self-service checkout system including one or more registration apparatuses with which a commodity to be purchased by a customer (hereinafter referred to as purchase commodity) is registered by a store clerk and one or more settlement apparatuses with which the customer performs settlement based on registration information corresponding to the purchase commodity registered by the registration apparatus. Specifically, in this embodiment, the fraud detection system is applied to the semi-self-service checkout system explained above. Note that the settlement apparatus can also be referred to as checkout machine, settlement terminal, checkout apparatus, and checkout terminal.

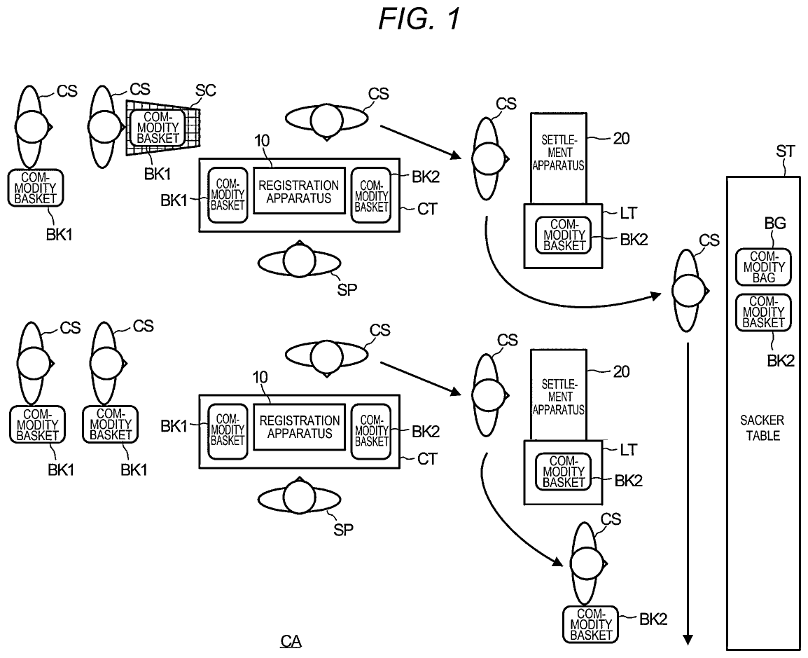

FIG. 1 is a diagram illustrating a disposition form example of a semi-self-service checkout system in a store. As illustrated in FIG. 1, two registration apparatuses 10 and two settlement apparatuses 20 are disposed in a checkout area CA provided in the store. Note that, in FIG. 1, an example is illustrated in which the two registration apparatuses 10 and the two settlement apparatuses 20 are installed in the checkout area CA. However, the number of registration apparatuses 10 and the number of settlement apparatuses 20 installed in the checkout area CA are not particularly limited. The number of registration apparatuses 10 and the number of settlement apparatuses 20 do not need to be the same and may be different from each other.

The registration apparatus 10 is an apparatus for a store clerk SP to perform commodity registration for a purchase commodity. The registration apparatus 10 is installed on a counter table CT. The settlement apparatus 20 is an apparatus for a customer CS to execute settlement processing for a commodity purchased by the customer CS. As illustrated in FIG. 1, the settlement apparatus 20 is installed in a halfway position of a line of flow from the counter table CT, on which the registration apparatus 10 is installed, to a sacker table ST.

Here, a use form example of the checkout system in the checkout area CA is explained. If entering from an entrance of the store, the customer CS goes to a commodity selling floor not illustrated in FIG. 1 and puts, in a commodity basket BK1, commodities that the customer CS desires to purchase. If finishing putting, in the commodity basket BK1, all commodities that the customer CS desires to purchase, the customer CS goes to the checkout area CA of the store and lines up behind other customers CS in a waiting lane for waiting for commodity registration. If the turn of the customer CS comes, the customer CS places the commodity basket BK1 on the counter table CT.

The store clerk SP operating the registration apparatus 10 performs operation for registering, as commodities in one transaction corresponding to the customer CS, the commodities put in the commodity basket BK1 carried by the customer CS. The store clerk SP puts, in a commodity basket BK2 for storing registered commodities, the commodities finished to be registered. The commodity basket BK1 and the commodity basket BK2 can be distinguished from each other by changing exterior forms such as changing colors or the like. If completing registering the commodities corresponding to the customer CS, the store clerk SP performs operation for instructing the registration apparatus 10 to calculate a total.

In response to the operation for instructing the total calculation being performed, the registration apparatus 10 calculates a total amount and the like of the commodities registered in the one transaction corresponding to the customer CS and generates registration information including the total amount and the like and information such as an apparatus number, a name of a store clerk in charge of the registration apparatus 10. The registration apparatus 10 specifies one of the settlement apparatuses 20 not in use. The registration apparatus 10 displays an apparatus number and the like of the specified settlement apparatus 20 on a display screen on the store clerk SP side and transmits the generated registration information to the settlement apparatus 20. The store clerk SP orally communicates the apparatus number and the like of the settlement apparatus 20 to the customer CS. The customer CS holds the commodity basket BK2 storing the registered purchase commodities and moves to, for settlement, a place where the settlement apparatus 20, the apparatus number and the like of which were orally communicated, is installed. A placing table LT for placing the commodity basket BK2 is installed beside the settlement apparatus 20. Accordingly, the customer CS moving to the place where the specified settlement apparatus 20 is installed places the commodity basket BK2 on the placing table LT installed beside the settlement apparatus 20 and can execute settlement processing using the settlement apparatus 20.

Note that, if there are only a small number of purchase commodities, in some case, the commodity baskets BK1 and BK2 are not used and the customer CS holds the commodities in an exposed state and moves. In such a case, the commodities are directly placed on the placing table LT.

In response to start operation from the customer CS or in response to detection of the customer CS by a sensor or the like, the settlement apparatus 20 displays, for example, settlement guidance according to the registration information transmitted from the registration apparatus 10. The customer CS deposits cash corresponding to a price according to the displayed guidance or executes payment of the price, that is, settlement processing according to use of an electronic commerce (EC) method such as credit card settlement, electronic money settlement, point settlement, or code settlement. The code settlement is referred to as mobile settlement, smartphone settlement, or the like as well and can be used by associating a code and a credit card or electronic money in advance in a commodity purchase application installed in an information terminal such as a smartphone owned by the customer CS. The settlement apparatus 20 dispenses a receipt according to the end of the settlement. The customer CS receives the dispensed receipt. The customer CS having finished the settlement holds the commodity basket BK2 storing the purchase commodities and moves to, for example, the sacker table ST and can transfer the commodities from the commodity basket BK2 to a commodity bag BG or the like using the sacker table ST. The customer CS having transferred the commodities to the commodity bag BG goes to the outside of the checkout area CA from a not-illustrated exit of the checkout area CA and further goes to the outside of the store.

As explained above, the semi-self-service checkout system has a configuration in which the registration apparatus 10 with which the store clerk SP performs operation for registering a purchase commodity purchased by the customer CS and the settlement apparatus 20 with which the customer CS executes the settlement processing are separately provided. In the store including the semi-self-service checkout system explained above, it is likely that a fraudulent act called “cart missing” of going to the outside of the store while holding unsettled commodities without performing settlement for purchase commodities is performed. In this embodiment, performance for detecting such a fraudulent act in the semi-self-service checkout system is improved to suppress the fraudulent act. That is, in this embodiment, the settlement apparatus 20 is a target apparatus that is a fraud detection target.

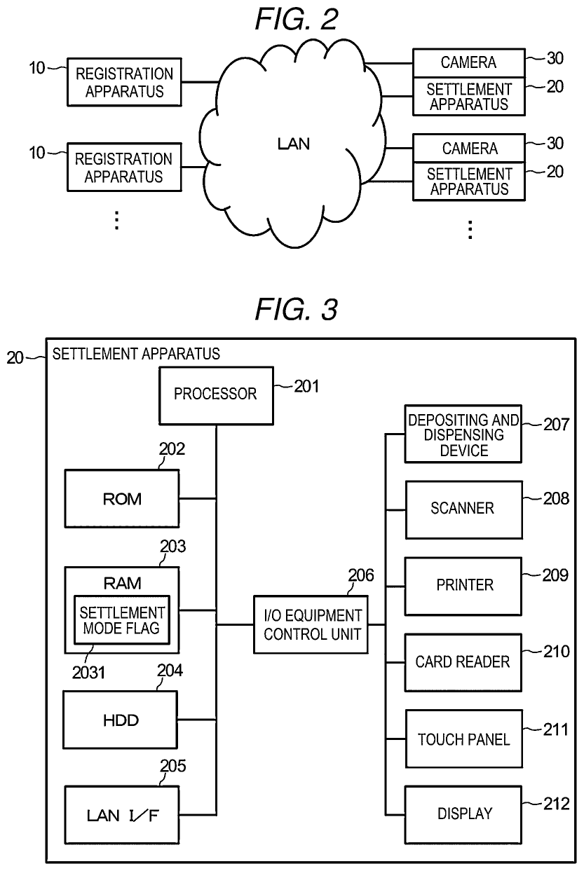

FIG. 2 is a block configuration diagram of the semi-self-service checkout system to which the fraud detection system according to the first embodiment is applied. In the checkout system, a plurality of registration apparatuses 10, a plurality of settlement apparatuses 20, and a plurality of cameras 30 are connected via a LAN (Local Area Network). The cameras 30 are provided to respectively correspond to the settlement apparatuses 20. That is, the settlement apparatuses 20 and the cameras 30 have a one-to-one correspondence relation. Note that the LAN may be a wired LAN or may be a wireless LAN. Further, the wired LAN and the wireless LAN may be mixed.

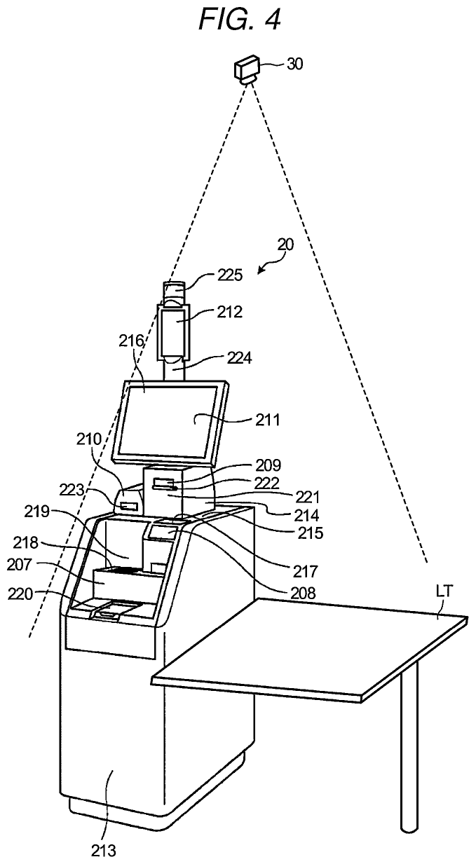

FIG. 3 is a block diagram illustrating a main part configuration of the settlement apparatus 20 to which the fraud detection apparatus according to the first embodiment is applied, that is, in which the fraud detection apparatus is incorporated. FIG. 4 is a perspective view illustrating the exterior of the settlement apparatus 20. As illustrated in FIG. 3, the settlement apparatus 20 includes a processor 201, a ROM (Read Only Memory) 202, a RAM (Random Access Memory) 203, a HDD (Hard Disk Drive) 204, a LAN interface 205, an I/O (Input/Output) equipment control unit 206, a depositing and dispensing device 207, a scanner 208, a printer 209, a card reader 210, a touch panel 211, and a display 212. Note that, in FIG. 3, “interface” is abbreviated as “I/F”. The processor 201 and a memory including the ROM 202 and the RAM 203 are connected, whereby a computer of the settlement apparatus 20 is configured.

The processor 201 is equivalent to a central part of the computer. The processor 201 controls the units according to an operating system or a control program in order to implement various functions of the settlement apparatus 20 and the fraud detection apparatus according to this embodiment. The processor 201 is, for example, a CPU (Central Processing Unit). The processor 201 may be, for example, an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), or an FPGA (Field Programmable Gate Array). Alternatively, the processor 201 may be a combination of a plurality of devices among these devices.

The ROM 202 and the RAM 203 are equivalent to a main storage part of the computer. The ROM 202 stores the operating system or the control program. The RAM 203 stores data necessary for the processor 201 in executing processing for controlling the units. The RAM 203 stores a settlement mode flag 2031 as one of the data. The settlement mode flag 2031 is, for example, a 1-bit flag that is set, while settlement processing is carried out, to indicate that the settlement processing is carried out. The RAM 203 can store, as one of the data, the registration information transmitted from the registration apparatus 10. Further, the RAM 203 is used as a work area where data is rewritten as appropriate by the processor 201.

The HDD 204 stores various control programs. The control programs can include a fraud detection program for causing the settlement apparatus 20 to operate as the fraud detection apparatus according to the embodiment. The HDD 204 can also store a log of the settlement processing as log data. Note that the settlement apparatus 20 may include a rewritable storage device such as an EEPROM (Electric Erasable Programmable Read-Only Memory) or an SSD (Solid State Drive) instead of or in addition to the HDD 204.

The LAN interface 205 is a communication device for communicating with the registration apparatus 10 and the camera 30 via a LAN.

The I/O equipment control unit 206 controls control information transmission from the processor 201 to the depositing and dispensing device 207, the scanner 208, the printer 209, the card reader 210, the touch panel 211, and the display 212 and data transmission in the opposite direction from the depositing and dispending device 207, the scanner 208, the printer 209, the card reader 210, the touch panel 211, and the display 212 to the processor 201.

The depositing and dispensing device 207, the scanner 208, the printer 209, the card reader 210, the touch panel 211, and the display 212 are explained below.

As illustrated in FIG. 4, the settlement apparatus 20 includes a first housing 213 and a second housing 214. The first housing 213 includes the depositing and dispensing device 207 and the scanner 208. The second housing 214 is placed on an upper surface 215 of the first housing 213 and includes a display 216, the printer 209, and the card reader 210.

The depositing and dispensing device 207 includes a coin depositing port 217, a bill depositing port 218, a bill dispensing port 219, and a coin dispensing section 220. The depositing and dispensing device 207 stores bills deposited to the bill depositing port 218 in a bill storing section (not illustrated). The depositing and dispending device 207 stores coins deposited to the coin depositing port 217 in a coin storing section (not illustrated). The depositing and dispending device 207 dispenses bill change to the bill dispensing port 219 in response to a change dispending request from the processor 201. The depositing and dispensing device 207 dispenses coin change to the coin dispensing section 220 in response to a change dispensing request from the processor 201.

The scanner 208 is an image sensor such as a CCD (Charge Coupled Device), which functions as an imaging unit, or an optical scanner for reading a code symbol for code settlement.

The printer 209 includes a printing unit (not illustrated) incorporated in the second housing 214 and a receipt dispensing port 222 provided on a front surface 221 of the second housing 214. The printer 209 prints a receipt and dispenses the receipt from the receipt dispensing port 222 according to the control of the processor 201.

The card reader 210 is disposed on the left side of the second housing 214 and on the upper surface 215 of the first housing 213. The card reader 210 reads information from and writes information in a credit card, a member card, or the like inserted from a card insertion port 223. The card reader 210 may include a wireless communication function for wirelessly communicating with a credit card mounted with a noncontact IC chip or an IC tag or a smartphone and enabling noncontact settlement called touch settlement, contactless, or electronic money settlement.

The touch panel 211 is provided on the surface of the display 216 attached above the second housing 214. The display 216 is configured by, for example, a liquid crystal panel and displays information concerning an operation state of the settlement apparatus 20 as images and characters. The touch panel 211 is provided on the surface of the display 216 and outputs information based on a position touched by the customer CS to the processor 201.

The settlement apparatus 20 includes a columnar display pole 224 erected on the rear side of the upper surface 215 of the first housing 213. The display pole 224 includes a light emitting unit 225 at the upper distal end portion.

The light emitting unit 225 includes a plurality of LEDs (Light Emitting Diodes) that emit light in blue and a plurality of LEDs that emit light in red. Note that the pluralities of LEDs are provided in order to obtain light emission intensity. Therefore, single LEDs of colors may be provided if intensity is maintained by the single LEDs. The light emitting unit 225 may use LEDs of colors different from blue and red or may use other light emitting elements. Since the light emitting unit 225 is provided at the upper end of the display pole 224 having height, the light emitting unit 225 can be easily viewed not only from the store clerk SP, who is an operator of the registration apparatus 10, but also from the other store clerks SP. Since the light emission can be easily checked from the position of the registration apparatus 10 as well, the light emission can be easily visually checked for the customer CS standing in front of the registration apparatus 10.

If the settlement apparatus 20 receives the registration information from the registration apparatus 10, the light emitting unit 225 emits light in a first light emission state, for example, blue flashing indicating a state of waiting for the customer CS. If it is likely that a fraud such as cart missing occurred in settlement processing relating to the registration information received from the registration apparatus 10 by the settlement apparatus 20, the light emitting unit 225 changes to a second light emission state, for example, red flashing and notifies an abnormality to the store clerk SP.

By switching a light emission pattern of the light emitting unit 225 in this way, it is possible to call attention of the store clerk SP if it is likely that cart missing occurred. A configuration in which the light emission pattern changes if it is likely that a fraud such as cart missing occurred is adopted to inform a customer that monitoring for fraudulent acts is performed, thereby suppressing fraudulent acts. A method of determining fraud occurrence and switching the light emission pattern is explained below together with a functional configuration of the processor 201 of the settlement apparatus 20.

The display pole 224 includes, below the light emitting unit 225, the display 212 that displays images and characters. The display 212 is configured by, for example, a liquid crystal panel. The display 212 displays, for example, content of an error that occurred in the settlement apparatus 20.

The customer CS operates the settlement apparatus 20 and performs processing for paying a price of a commodity, that is, settlement processing by cash, a credit card, electronic money, or the like. In the settlement processing, the settlement apparatus 20 displays a total amount billed of one transaction based on the registration information, that is, transaction information received from the registration apparatus 10 and controls processing relating to checkout for the amount. As explained above, the registration information includes information such as a breakdown of purchase commodities, a total amount, an apparatus number of the registration apparatus 10, which is a transmission source, and a name of a store clerk in charge in one transaction set as a processing target. The registration information may further include other information necessary for receipt printing. For example, the registration information can include sales promotion information for receipt printing as the other information.

As illustrated in FIG. 4, the placing table LT for placing a commodity or the commodity basket BK2 is installed, for example, on the right side facing the front of the settlement apparatus 20. The placing table LT is an example of a placing section on which at least one of a commodity and the commodity basket BK2 is placed if the settlement processing is executed in the settlement apparatus 20. The camera 30 is installed above the settlement apparatus 20 and the placing table LT to image the periphery of the settlement apparatus 20 and the placing table LT. For example, an arm extending upward is attached to the settlement apparatus 20. The camera 30 is installed at the distal end portion of the arm to face downward. Alternatively, the camera 30 may be installed by being embedded in or suspended from a ceiling. In this embodiment, a method of installing the camera 30 is not particularly limited if the camera 30 is capable of imaging a necessary area.

A fraud detection operation by the fraud detection apparatus applied to the fraud detection system and the settlement apparatus 20 according to this embodiment having the configurations explained above is explained below.

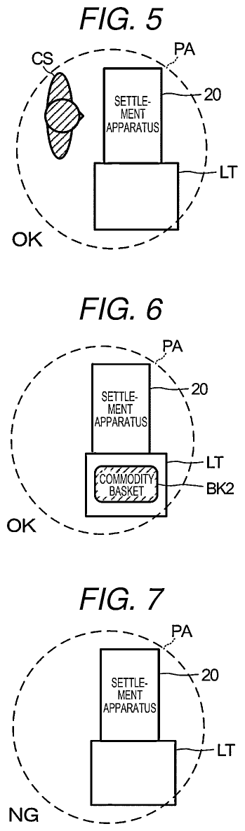

FIGS. 5 to 7 are schematic diagrams for explaining a situation in which the processor 201 of the settlement apparatus 20 to which the fraud detection apparatus is applied determines presence or absence of a fraud. If the settlement apparatus 20 comes into a settlement waiting state in which the settlement apparatus 20 received the registration information from the registration apparatus 10, an area including the periphery of the settlement apparatus 20 and the placing table LT is imaged by the camera 30. In FIGS. 5 to 7, this area is illustrated as an imaging area PA. For example, if a person is detected in the front of the settlement apparatus 20 as illustrated in FIG. 5, the processor 201 determines OK, that is, that a fraud is absent. For example, if a commodity or the commodity basket BK2 is detected on the placing table LT as illustrated in FIG. 6, the processor 201 also determines OK, that is, that a fraud is absent. In contrast, for example, if both of a person in the front of the settlement apparatus 20 and a commodity or the commodity basket BK2 on the placing table LT are not detected as illustrated in FIG. 7, the processor 201 determines NG, that is, that a fraud is present.

Next, a specific example of operations of the settlement apparatus 20 and the fraud detection apparatus applied to the settlement apparatus 20 is explained.

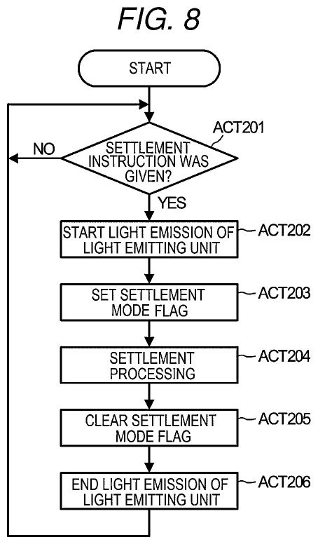

FIG. 8 is a flowchart illustrating a main part procedure of information processing relating to settlement executed by the processor 201 of the settlement apparatus 20. For example, in response to power-on of the settlement apparatus 20 or predetermined start operation by the touch panel 211 in a store clerk mode by the store clerk SP, the processor 201 executes this processing based on a control program stored in the ROM 202 or the HDD 204. Note that, unless particularly explained otherwise, it is assumed that a processing operation of the processor 201 shifts to ACT (x+1) after ACT x (x is a natural number). The procedure illustrated in FIG. 8 is an example. The procedure is not particularly limited if the same result can be obtained.

In ACT 201, the processor 201 determines whether a settlement instruction was given. Specifically, the processor 201 performs this determination by determining whether the registration information transmitted from any registration apparatus 10 via a LAN was received by the LAN interface 205. If the settlement instruction was not given, the processor 201 determines NO in ACT 201 and repeats ACT 201. In this way, the processor 201 waits for the settlement instruction from any registration apparatus 10. If the settlement instruction was given, the processor 201 determines YES in ACT 201 and proceeds to ACT 202.

In ACT 202, the processor 201 starts light emission of the light emitting unit 225. Although not illustrated in FIG. 3, the light emitting unit 225 is also connected to the I/O equipment control unit 206. The processor 201 can control a lighting state of the light emitting unit 225 via the I/O equipment control unit 206. Therefore, the processor 201 causes the light emitting unit 225 to emit light in the first light emission state, for example, blue flashing indicating a state of waiting for the customer CS.

In ACT 203, the processor 201 sets, in the RAM 203, a settlement mode flag 2031 indicating that settlement processing is being carried out. For example, the processor 201 sets a value of the settlement mode flag 2031 stored in the RAM 203 to “1”.

In ACT 204, the processor 201 executes the settlement processing. In the settlement processing, the processor 201 causes the display 216 to display settlement guidance or the like according to the received registration information, receives settlement by the customer CS with the depositing and dispensing device 207, the scanner 208, or the card reader 210, and, if the settlement ended, dispenses a receipt with the printer 209.

After the end of the settlement processing, in ACT 205, the processor 201 clears the settlement mode flag 2031 set in the RAM 203. For example, the processor 201 sets the value of the settlement mode flag 2031 stored in the RAM 203 to “0”.

In ACT 206, the processor 201 ends the light emission of the light emitting unit 225. Thereafter, the processor 201 proceeds to ACT 201.

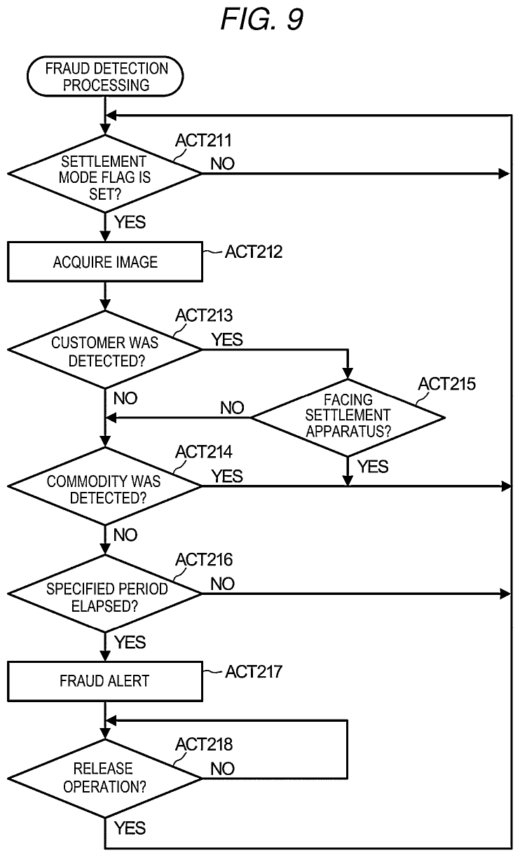

FIG. 9 is a flowchart illustrating a main part procedure of fraud detection processing executed by the processor 201 of the settlement apparatus 20. The fraud detection processing is processing of the fraud detection apparatus by the processor 201. For example, the processor 201 starts the fraud detection processing simultaneously with the start of the information processing relating to the settlement illustrated in FIG. 8. That is, the processor 201 executes the information processing relating to the settlement and the fraud detection processing in parallel.

In ACT 211, the processor 201 determines whether the settlement mode flag 2031 is set in the RAM 203. That is, the processor 201 determines whether the value of the settlement mode flag 2031 stored in the RAM 203 is “1”. If the settlement mode flag 2031 is not set, the processor 201 determines NO in ACT 211 and repeats ACT 211. In this way, the processor 201 waits for the settlement mode flag 2031 to be set, that is, waits for the start of the settlement processing. If the settlement mode flag 2031 was set, the processor 201 determines YES in ACT 211 and proceeds to ACT 212.

In ACT 212, the processor 201 acquires a captured image from the camera 30 corresponding to the settlement apparatus 20. For example, correspondence relation information indicating which of the plurality of cameras 30 corresponds to the settlement apparatus 20 is stored in advance in the HDD 204. The processor 201 acquires, based on the correspondence relation information, via the LAN interface 205, a captured image of the corresponding camera 30 connected to the LAN.

In ACT 213, the processor 201 determines, based on the acquired captured image, whether the customer CS was detected. That is, the processor 201 determines whether a person is present or absent in the front of the settlement apparatus 20. If the customer CS was detected, the processor 201 determines YES in ACT 213 and proceeds to ACT 215. If the customer CS was not detected, the processor 201 determines NO in ACT 213 and proceeds to ACT 214.

In ACT 214, the processor 201 determines, based on the acquired captured image, whether a commodity was detected. For example, the processor 201 determines whether a commodity or the commodity basket BK2 is placed on the placing table LT. If a commodity or the commodity basket BK2 is placed, the processor 201 assumes that the commodity was detected, determines YES in ACT 214, and proceeds to ACT 211. If a commodity was not detected, the processor 201 determines NO in ACT 214 and proceeds to ACT 216.

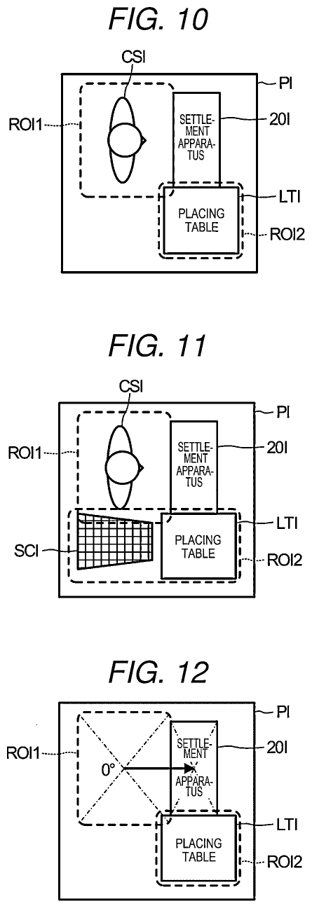

Here, the detection of a customer and a commodity in ACT 213 and ACT 214 is explained more in detail. FIG. 10 is a schematic diagram for explaining a detection area in a captured image. Since the camera 30 is fixedly installed, a positional relation between the camera 30 and the settlement apparatus 20 and the placing table LT does not change. Therefore, as illustrated in FIG. 10, a captured image PI always includes a settlement apparatus image 201, which is an image of the settlement apparatus 20, and a placing table image LTI, which is an image of the placing table LT. Depending on a case, the captured image PI also includes a customer image CSI, which is an image of the customer CS. The processor 201 sets, in the captured image PI, a customer detection area ROI1 for detecting a customer and a commodity detection area ROI2 for detecting a commodity, segments images of the respective detection areas, and detects a customer or a commodity from the segmented images. Note that, since a positional relation among the camera 30, the settlement apparatus 20, and the placing table LT does not change, a positional relation between the customer detection area ROI1 and the commodity detection area ROI2 set by the processor 201 also does not change.

Specifically, the processor 201 sets a fixed area in the front of the settlement apparatus 20 as the customer detection area ROI1. The processor 201 detects, using a known image recognition technique, whether a person is present in an image of the customer detection area ROI1. For example, the processor 201 calculates a histograms of oriented gradients (HOG) feature value from the image of the customer detection area ROI1 and linearly classifies the feature value with a learned support vector machine (SVM) to thereby detect a person in a standing posture in the image of the customer detection area ROI1. An area corresponding to the customer detection area ROI1 in the checkout area CA is an example of a first area in the periphery of the settlement apparatus 20 that is a fraud detection target. The processor 201 is an example of a person detecting unit that detects, based on the captured image PI captured by the camera 30, a person in the first area in the periphery of the settlement apparatus 20. The camera 30 is an example of an image sensor.

The processor 201 sets a fixed area including the placing table LT as the commodity detection area ROI2. The processor 201 detects whether a commodity or the commodity basket BK2 is present in an image of the commodity detection area ROI2. For example, the processor 201 acquires, in advance, an image of the commodity detection area ROI2 at the time when a commodity or the commodity basket BK2 is not placed on the placing table LT and compares the image and a current image of the commodity detection area ROI2 to thereby recognize a commodity or the commodity basket BK2. A known image processing technique is used for the recognition. For example, the processor 201 calculates HOG feature values from the images and recognizes, according to whether a Euclidean distance of the calculated HOG feature values exceeds a threshold, whether a commodity or the commodity basket BK2 is present. An area corresponding to the commodity detection area ROI2 in the checkout area CA is an example of a second area in the periphery of the settlement apparatus 20. The commodity basket BK2 is an example of a storing body that stores a commodity. The processor 201 is an example of a commodity detecting unit that detects, based on an image capturing the settlement apparatus 20 that is a target apparatus, at least one of a commodity and a storing body storing the commodity in the second area in the periphery of the settlement apparatus 20.

FIG. 11 is a schematic diagram for explaining another example of the detection area in the captured image. The customer CS does not always store a commodity in the commodity basket BK2 and move to the settlement apparatus 20 and sometimes uses a commodity cart SC. That is, the customer CS loads, that is, stores, in the commodity cart SC, the commodity basket BK2 storing a commodity and moves. Accordingly, the commodity cart SC is an example of the storing body that stores a commodity. If executing settlement processing in the settlement apparatus 20, the customer CS retains the commodity cart CS in a retaining section around the placing table LT. In order to cope with the use of the commodity cart SC, as illustrated in FIG. 11, the commodity detection area ROI2 set by the processor 201 is set as an area where a commodity cart image SCI, which is an image of the commodity cart SC, in the captured image PI is also fit in the commodity detection area ROI2. As explained above, if the settlement processing is executed by the settlement apparatus 20, the second area in the periphery of the settlement apparatus 20 can be set as an area including the placing table LT, which is a placing section on which the commodity basket BK2 is placed, and the retaining section in which the commodity cart SC is retained in the periphery of the placing table LT. The processor 201 detects whether any one of a commodity, the commodity basket BK2, and the commodity cart SC is present in an image of the commodity detection area ROI2. Note that parts of the customer detection area ROI1 and the commodity detection area ROI2 may overlap.

As explained above, the processor 201 segments, from the captured image PI including the first area and the second area captured by the camera 30, an image in the customer detection area ROI1 corresponding to the first area and detects a person and segments, from the captured image PI, an image in the commodity detection area ROI2 corresponding to the second area and detects a commodity, the commodity basket BK2 that is the storing body, or the commodity cart SC.

Referring back to FIG. 9, in ACT 215, the processor 201 determines whether the customer CS is facing the settlement apparatus 20. The processor 201 is an example of a person direction detecting unit that detects the direction of a person detected by the person detecting unit. If the customer CS is facing the settlement apparatus 20, the processor 201 determines YES in ACT 215 and proceeds to ACT 211. If the customer CS is not facing the settlement apparatus 20, the processor 201 determines NO in ACT 215 and proceeds to ACT 214. That is, the processor 201 proceeds to ACT 214 as in the case in which, although the processor 201 determines in ACT 213 that the customer CS was detected, the customer CS was not detected. That is, a detection result of the customer CS is neglected. In this way, the processor 201 is an example of a detection disabling unit that disables the detection of the person detecting unit if the direction of the person is not the direction of the settlement apparatus 20.

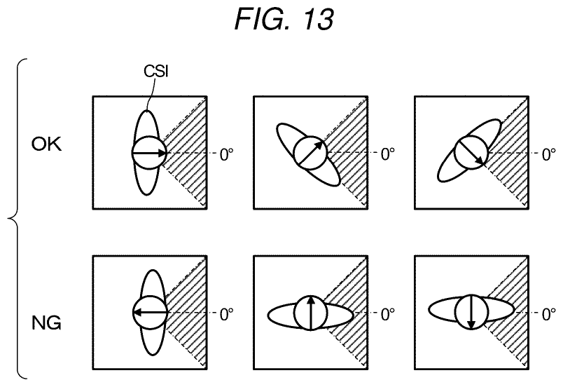

Here, the direction of a customer determined in ACT 215 is explained more in detail. FIG. 12 is a schematic diagram for explaining 0° of the direction of a customer in a captured image. As illustrated in FIG. 12, the processor 201 sets, as 0°, a direction from the center of the customer detection area ROI1 set in the periphery of the settlement apparatus 20 to the center of the settlement apparatus image 201 that is the image of the settlement apparatus 20.

FIG. 13 is a schematic diagram for explaining a range in which it is determined that the customer CS is facing the settlement apparatus 20. As illustrated in FIG. 13, if the direction of a person detected from the customer detection area ROI1 is ±45° or less, the processor 201 determines OK, that is, that the customer CS is facing the settlement apparatus 20. In other words, if the direction of the person detected from the customer detection area ROI1 is not ±45° or less, the processor 201 determines NG, that is, that the customer CS is not facing the settlement apparatus 20. Note that “the direction of a person” referred to herein means “the direction of a face and a body” in the customer image CSI. Since the camera 30 images the customer CS from above, the processor 201 can easily determine the direction of the face and the direction of the body. If the direction of the face and the direction of the body are different, the processor 201 may prioritize the direction of determined one such as the face or may calculate the direction by taking an average or a weighted average of the directions. The position of the customer image CSI in the customer detection area ROI1 is not fixed. In ACT 215, the processor 201 determines only the direction without considering a position.

Referring back to FIG. 9, in ACT 216, the processor 201 determines whether a specified period elapsed after the settlement mode flag 2031 was set. The specified period may be a time or may be the number of acquired captured images PI, that is, the number of frames. The specified period can be set based on the distance from the registration apparatus 10 to the settlement apparatus 20. The processor 201 sets the specified period based on an apparatus number of the registration apparatus 10 included in the registration information. For example, distance information for each registration apparatus 10 may be stored in the HDD 204 and the processor 201 may calculate the specified period from the distance information or the specified period for each registration apparatus 10 may be stored in advance in the HDD 204. If the specified period did not elapse, the processor 201 determines NO in ACT 216 and proceeds to ACT 211. If the specified period elapsed, the processor 201 determines YES in ACT 216 and proceeds to ACT 217.

Note that, if the settlement processing ended and the settlement mode flag 2031 was cleared in a loop of ACT 211 to ACT 216, it is determined NO in ACT 211. Therefore, the processing in ACT 212 to ACT 216 is ended.

In ACT 217, the processor 201 assumes that it is highly likely that a fraudulent act of taking out a registered commodity to the outside of the store without settling an account occurred and performs a fraud alert. The processor 201 is an example of a fraud alerting unit that alerts the store clerk SP to a fraud if the person detecting unit does not detect a person and the commodity detecting unit does not detect both of a commodity and a storing body in a state in which settlement processing for a commodity is executed.

The fraud alert includes, for example, light emission of the light emitting unit 225. That is, the processor 201 causes the light emitting unit 225 to emit light in the second light emission state, that is, red flashing to notify the possibility of fraud occurrence to the store clerk SP. As the fraud alert, fraud information indicating the high possibility of fraud occurrence may be transmitted to the registration apparatus 10, which is a transmission source of the registration information, by the LAN interface 205 via the LAN. If receiving the fraud information, the registration apparatus 10 displays a display screen on the store clerk SP side of the registration apparatus 10 to notify the possibility of fraud occurrence to the store clerk SP. Further, if a camera is disposed on the registration apparatus 10 side as well to capture an image of a registering customer such as a face image, the registration apparatus 10 protects the image of the registering customer to which the settlement apparatus 20 that transmitted the fraud information is allocated not to be erased and adds a file name to the image and stores the image as another file.

In ACT 218, the processor 201 determines whether predetermined operation for releasing the fraud alert was performed. The release operation may be operation of the touch panel 211 in the store clerk mode by the store clerk SP or may be reception of release information transmitted according to the release operation in the registration apparatus 10. If the release operation is not performed, the processor 201 determines NO in ACT 218 and repeats ACT 218. In this way, the processor 201 waits for the release operation. If the release operation was performed, the processor 201 determines YES in ACT 218 and proceeds to ACT 211.

As explained above, the processor 201 of the settlement apparatus 20 to which the fraud detection apparatus according to the first embodiment is applied detects a person in the first area in the periphery of the settlement apparatus 20 that is a fraud detection target, detects at least one of a commodity and at least one of the commodity basket BK2 and the commodity cart SC storing the commodity in the second area in the periphery of the settlement apparatus 20 and alerts the store clerk SP to a fraud if a person is not detected and all of a commodity, the commodity basket BK2, and the commodity cart SC are not detected in a state in which settlement processing by the customer CS is executed for the commodity.

As explained above, with the fraud detection apparatus according to the first embodiment, since it is unnecessary to detect who a person is, a processor having a high-performance processing ability is not required as the processor 201. Accordingly, it is possible to inexpensively and accurately detect a fraudulent act of taking out a registered commodity to the outside of the store without settling an account. Based on the premise that a registering customer and a settling customer are the same person, if a plurality of people do shopping, for example, if a husband carries a commodity to the registration apparatus 10 and a wife settles an account in the settlement apparatus 20, it is recognized that a fraudulent act occurred. In contrast, since the fraud detection apparatus according to the first embodiment is not based on the premise that a registering customer and a settling customer are the same person, such a wrong fraud alert does not occur.

The processor 201 of the settlement apparatus 20 to which the fraud detection apparatus according to the first embodiment is applied detects the direction of a detected person and, if the direction is not the direction of the settlement apparatus 20, disables the detection of the person detecting unit.

Accordingly, with the fraud detection apparatus according to the first embodiment, if the detected person is not facing the settlement apparatus 20, it is likely that the person is not a person who performs settlement. Therefore, it is possible to securely perform a fraud alert by neglecting the detection of such a person.

Note that the second area is an area including the placing table LT on which the customer CS places at least one of a commodity and the commodity basket BK2 if the customer CS executes settlement processing in the settlement apparatus 20.

Alternatively, the second area is an area including, in addition to the placing table LT, the retaining section in the periphery of the placing table LT in which the commodity cart SC is retained if the customer CS executes the settlement processing in the settlement apparatus 20.

Accordingly, with the fraud detection apparatus according to the first embodiment, it is possible to perform commodity detection targeting an area with a high probability of presence of a commodity if the customer CS executes the settlement processing.

The processor 201 of the settlement apparatus 20 to which the fraud detection apparatus according to the first embodiment is applied detects a person based on an image in the customer detection area ROI1 corresponding to a captured image of the first area captured by the camera 30.

More specifically, the processor 201 segments an image in the customer detection area ROI1 corresponding to the first area from the captured image PI including the first area and the second area captured by the camera 30 and detects a person.

As explained above, with the fraud detection apparatus according to the first embodiment, it is possible to detect a person by narrowing down the captured image PI captured by the camera 30 to an image of a specific area. Accordingly, since the entire captured image PI is not processed as a target, the processing can be increased in speed. This person detection does not include recognition of the person and only detects whether the person is present or absent. Therefore, the processor 201 is not required to have a high processing ability.

The processor 201 of the settlement apparatus 20 to which the fraud detection apparatus according to the first embodiment is applied detects at least one of a commodity, the commodity basket BK2, and the commodity cart SC based on an image in the commodity detection area ROI2 corresponding to a captured image of the second area captured by the camera 30.

More specifically, the processor 201 segments an image in the commodity detection area ROI2 corresponding to the second area from the captured image PI including the first area and the second area captured by the camera 30 and detects at least one of a commodity, the commodity basket BK2, and the commodity cart SC.

As explained above, with the fraud detection apparatus according to the first embodiment, a commodity, the commodity basket BK2, and the commodity cart SC are detected by narrowing down the captured image PI captured by the camera 30 to an image of a specific area. Accordingly, since the entire captured image PI is not processed as a target, the processing can be increased in speed. This detection of the commodity and the like does not include recognition of what the commodity and the like are and only detects whether the commodity and the like are present or absent. Therefore, the processor 201 is not required to have a high processing ability.

### Second Embodiment

Next, a second embodiment is explained. Note that the same components and operations as the components and the operations in the first embodiment are denoted by the same reference numerals and signs as the reference numerals and signs in the first embodiment to omit explanation of the components and the operations.

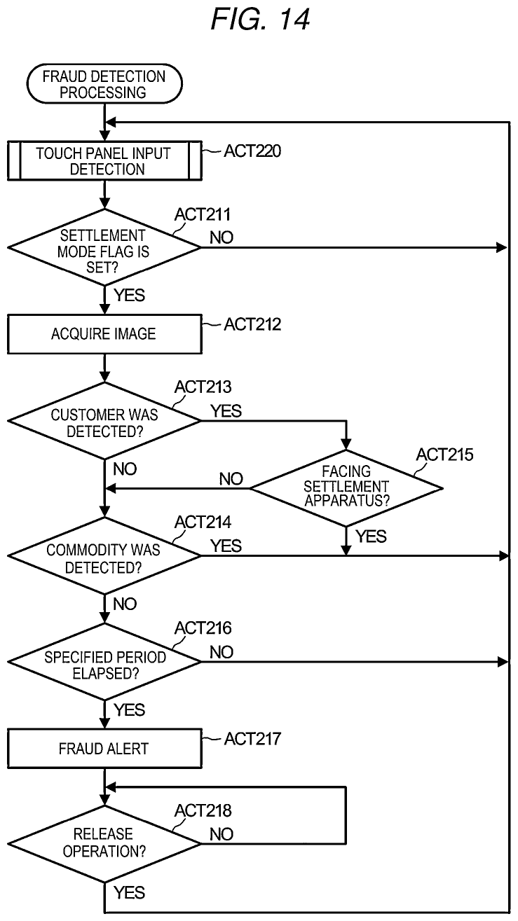

The second embodiment is different from the first embodiment in fraud detection processing in a fraud detection apparatus applied to the settlement apparatus 20. FIG. 14 is a flowchart illustrating a main part procedure of fraud detection processing executed by the processor 201 of the settlement apparatus 20 to which the fraud detection apparatus according to the second embodiment is applied. As illustrated in FIG. 14, in the second embodiment, before the processing in ACT 211 for detecting whether the settlement mode flag 2031 is set, in ACT 220, a touch panel input detection subroutine is inserted.

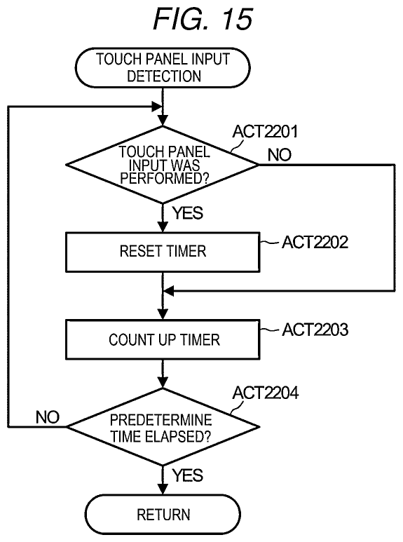

FIG. 15 is a flowchart illustrating a main part procedure of the touch panel input detection subroutine executed in ACT 220. In the touch panel input detection subroutine, in ACT 2201, the processor 201 determines whether input operation of the customer CS to the touch panel 211 was performed. The processor 201 is an example of an input detecting unit that detects input operation to the settlement apparatus 20 by a person. If input operation to the touch panel 211 was performed, the processor 201 determines YES in ACT 2201 and proceeds to ACT 2202. If input operation to the touch panel 211 was not performed, the processor 201 determines NO in ACT 2201 and proceeds to ACT 2203.

In ACT 2202, the processor 201 resets a timer incorporated in the processor 201 or a separately provided timer (not illustrated).

In ACT 2203, the processor 201 counts up the timer.

In ACT 2204, the processor 201 determines whether a time clocked by the timer exceeded a predetermined time. The predetermined time is not particularly limited but is set to, for example, approximately 5 seconds. If the time did not exceed the predetermined time, the processor 201 determines NO in ACT 2204 and proceeds to ACT 2201. If the time exceeded the predetermined time, the processor 201 determines YES in ACT 2204, ends the touch panel input detection subroutine, and proceeds to ACT 221.

By executing the touch panel input detection subroutine before ACT 211, if input operation to the touch panel 211 is detected, the fraud detection processing is not carried out for the predetermined time. In other words, for the predetermined time after the touch panel 211 was operated, the fraud alert in ACT 217 is not performed, that is, the fraud alert is suppressed. In the first place, the touch panel 211 being operated means that the customer CS is present in front of the settlement apparatus 20. Therefore, it is unnecessary to perform customer detection, that is, a situation in which the fraud alert is performed does not occur. However, since the operation of the touch panel 211 is not equal to settlement, it is still likely that a customer leaves without settling an account. Therefore, here, the suppression of the fraud alert is released after the predetermined time elapsed. As explained above, the processor 201 is an example of an alert suppressing unit that suppresses alert processing of the fraud alerting unit for the predetermined time if input operation to the settlement apparatus 20 by a person was detected.

As explained above, if detecting input operation to the touch panel 211 of the settlement apparatus 20 by the customer CS, the processor 201 of the settlement apparatus 20 to which the fraud detection apparatus according to the second embodiment is applied suppresses fraud alert processing for the predetermined time.

As explained above, with the fraud detection apparatus according to the second embodiment, it is possible not to perform unnecessary processing if the touch panel 211 is operated. It is possible to, by providing the predetermined time, prevent a fraud from being overlooked.

### Third Embodiment

Next, a third embodiment is explained. Note that the same components and operations as the components and the operations in the first embodiment are denoted by the same reference numerals and signs as the reference numerals and signs in the first embodiment to omit explanation of the components and the operations.

The fraud detection system according to the first embodiment corresponds to the semi-self-service checkout system including the registration apparatus 10 and the settlement apparatus 20. This embodiment corresponds to a full-self-service checkout system in which a self-service POS terminal functioning as a registration and settlement apparatus integrating both functions of a registration apparatus and a settlement apparatus is used. That is, in this embodiment, the self-service POS terminal is a target apparatus that is a fraud detection target.

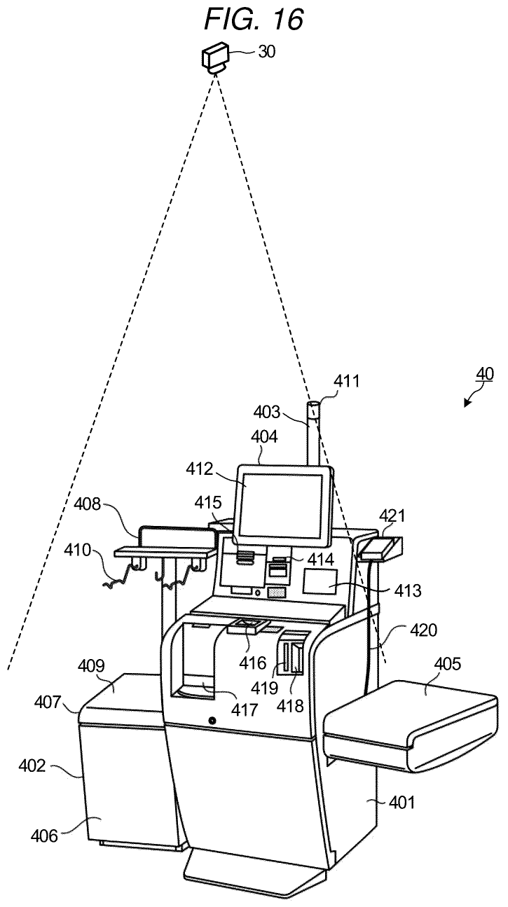

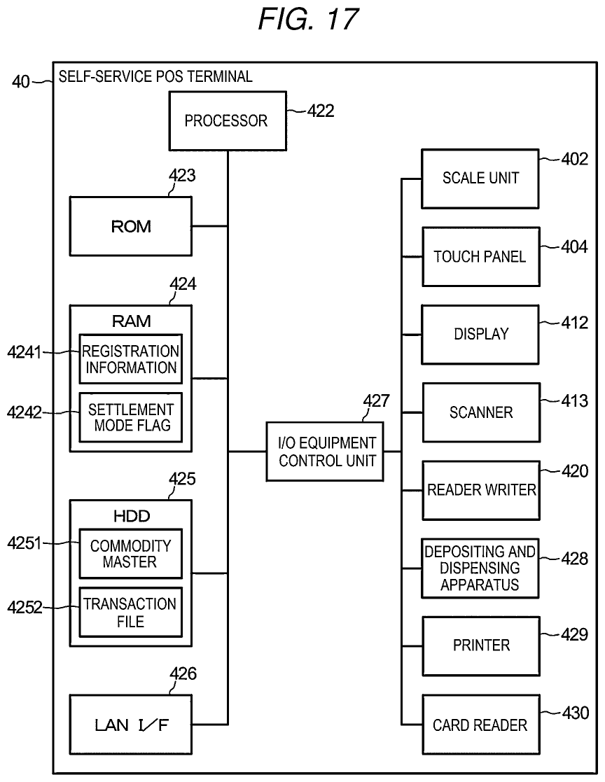

FIG. 16 is a perspective view illustrating the exterior of a self-service POS terminal 40 to which a fraud detection apparatus according to the third embodiment is applied, that is, in which the fraud detection apparatus is incorporated. FIG. 17 is a block diagram illustrating a main part configuration of the self-service POS terminal 40.

As illustrated in FIG. 16, the self-service POS terminal 40 includes a main body 401 installed on a floor surface and a scale unit 402 installed beside the main body 401. A display pole 403 and a touch panel 404 are attached to upper parts of the main body 401. In the main body 401, a basket table 405 is provided in the center of a side surface on the opposite side to a side where the scale unit 402 is installed. The basket table 405 is a table for the customer CS coming from a selling floor to place the commodity basket BK1 storing purchase commodities. The customer CS performs work while standing on the near side of the main body 401 in FIG. 16 to be able to view a screen of the touch panel 404. Therefore, if viewed from the customer CS, the basket table 405 is present on the right side across the main body 401 and the scale unit 402 is present on the left side. In the following explanation, the side where the customer CS stands is the front of the main body 401, the side where the scale unit 402 is installed is the left side of the main body 401, and the side where the basket table 405 is provided is the right side of the main body 401.

The scale unit 402 has structure in which a scale pan 407 is provided in an upper part of a housing 406 and a bag holder 408 is attached to an upper part of the scale pan 407. The upper surface of the scale pan 407 is a placing surface 409. The bag holder 408 includes a pair of holding arms 410. The commodity bag BG such as a register bag or a shopping bag, that is, a reusable shopping bag (a so-called My Bag) carried by the customer CS is held by the holding arms 410. The scale unit 402 measures the weight of commodities placed on the placing surface 409 while being put in the register bag or the reusable shopping bag held by the holding arms 410. The scale unit 402 including the bag holder 408 and the placing surface 409 is equivalent to the placing table LT in the first embodiment. The register bag or the reusable shopping bag, which is the commodity bag BG, is equivalent to the commodity basket BK2 in the first embodiment.

The display pole 403 includes, at the distal end portion thereof, a light emitting unit 411 that selectively emits light in, for example, blue and red. The display pole 403 displays a state of the self-service POS terminal 40, for example, standby, operating, calling, error, and fraud occurrence according to a light emission color and a light emitting state of the light emitting unit 411.

The touch panel 404 is configured by a display 412 for displaying various screens to a user who operates the self-service POS terminal 40 and a touch sensor for detecting touch input to the screens by the user. In the self-service POS terminal 40, the user is usually the customer CS.

A scanner 413, a card insertion port 414, and a receipt dispensing port 415 are disposed in the front of the main body 401. Further, a coin depositing port 416, a coin dispensing port 417, a bill depositing port 418, and a bill dispensing port 419 are also formed in the front of the main body 401. A communication cable 420 extends from the right side surface of the main body 401 to the outside. A reader writer 421 for an electronic money medium is connected to the distal end of the communication cable 420.

The camera 30 is disposed above the self-service POS terminal 40. The imaging area PA of the camera 30 includes the periphery of the self-service POS terminal 40. Specifically, the camera 30 is installed such that an image of the self-service POS terminal 40 including the scale unit 402 and an image of the customer CS operating the self-service POS terminal 40 are included in the captured image PI of the camera 30.

As illustrated in FIG. 17, the self-service POS terminal 40 includes a processor 422, a ROM 423, a RAM 424, a HDD 425, a LAN interface 426, an I/O equipment control unit 427, a depositing and dispensing device 428, a printer 429, and a card reader 430 and the touch panel 404, the display 412, and the scanner 413 explained above. The processor 422 and a memory including the ROM 423 and the RAM 424 are connected, whereby a computer of the self-service POS terminal 40 is configured.

The processor 422 is equivalent to a central part of the computer. The processor 422 controls the units according to an operating system or a control program in order to implement various functions of the self-service POS terminal 40 and the fraud detection apparatus according to this embodiment. The processor 422 may be, for example, a CPU, an MPU, an SoC, a DSP, a GPU, an ASIC, a PLD, or an FPGA. Alternatively, the processor 422 may be a combination of a plurality of devices among these devices.

The ROM 423 and the RAM 424 are equivalent to a main storage part of the computer. The ROM 423 stores the operating system or the control program. The RAM 424 stores data necessary for the processor 422 in executing processing for controlling the units. As one of the data, the RAM 424 stores registration information 4241 and a settlement mode flag 4242. The registration information 4241 includes a breakdown of purchase commodities and a total amount in one transaction. The settlement mode flag 4242 is the same as the settlement mode flag 2031 in the first embodiment. The RAM 424 is used as a work area where data is rewritten as appropriate by the processor 422.

The HDD 425 stores various control programs. The control programs can include a fraud detection program for causing the self-service POS terminal 40 to operate as the fraud detection apparatus according to the embodiment. The HDD 425 stores a commodity master 4251 that stores, for commodities sold in a store, commodity names, prices, and the like in association with commodity codes and a transaction file 4252 including registration information relating to a transaction. The transaction file 4252 is a data file for storing data relating to one commercial transaction processed by the self-service POS terminal 40. The transaction file 4252 stores data such as a transaction number, purchase commodity data, a total number of items, a total amount, a price-cut amount, and a settlement amount. The transaction number is a serial number issued every time a commercial transaction is processed by the self-service POS terminal 40. The purchase commodity data is record data created for each commodity traded by the commercial transaction identified by the transaction number. Here, the purchase commodity data is configured by items such as a commodity code, a commodity name, a price, the number of items, and an amount. The number of items is a number of purchased items of the commodity identified by the commodity code. The amount is an amount for the number of purchased items. The transaction file 4252 can store a plurality of purchase commodity data. The total number of items is the number of items obtained by totaling the numbers of items of the respective purchase commodity data. The total amount is an amount obtained by totaling amounts of the respective purchase commodity data. The price-cut amount is an amount cut from the total amount. The settlement amount is an amount obtained by subtracting the price-cut amount from the total amount. Note that the self-service POS terminal 40 may include a rewritable storage device such as an EEPROM or an SSD instead of or in addition to the HDD 425.

The LAN interface 426 is a communication device for communicating with the camera 30 via a LAN.

The I/O equipment control unit 427 controls control information transmission from the processor 422 to the scale unit 402, the touch panel 404, the display 412, the scanner 413, the reader writer 421, the depositing and dispensing device 428, the printer 429, and the card reader 430 and data transmission in the opposite direction from the scale unit 402, the touch panel 404, the display 412, the scanner 413, the reader writer 421, the depositing and dispensing device 428, the printer 429, and the card reader 430 to the processor 422.

The depositing and dispensing device 428 sorts, one by one, coins deposited to the coin depositing port 416, identifies denominations, and stores the coins in a safe for each of the denominations. The depositing and dispensing device 428 takes out, for example, based on change data, coins of denominations corresponding to the change data from the safe and dispenses the coins to the coin dispensing port 417. Further, the depositing and dispensing device 428 sorts, one by one, bills deposited to the bill depositing port 418, identifies denominations, and stores the bills in the safe for each of the denominations. The depositing and dispensing device 428 takes out, for example, based on change data, bills of denominations corresponding to the change data from the safe and dispenses the bills to the bill dispensing port 419.

The printer 429 prints, on receipt paper, handwritten receipt data or the like representing content of a commercial transaction. The receipt paper on which the handwritten receipt data is printed is discharged from the receipt dispensing port 415, cut by a not-illustrated cutter, and dispensed as a receipt or a handwritten receipt.

The card reader 430 reads card data recorded in a card medium such as a credit card or a point card. The card reader 430 draws, into the main body 401, the card medium inserted into the card insertion port 414, reads the card data, and thereafter discharges the card medium from the card insertion port 414.

The scanner 413 reads a code symbol from a commodity. Code symbols obtained by encoding commodity IDs or the like for identifying commodities sold in the store are added to the commodities. The code symbol is, for example, a barcode. The code symbol may be, for example, a two-dimensional data code. The scanner 413 may be a type for reading a code symbol by scanning the code symbol with laser light or may be a type for reading a code symbol from an image captured by an imaging device. The scanner 413 may be used to read a code symbol for code settlement.

The self-service POS terminal 40 and the fraud detection apparatus applied to the self-service POS terminal 40 having the configurations explained above operate as explained below.

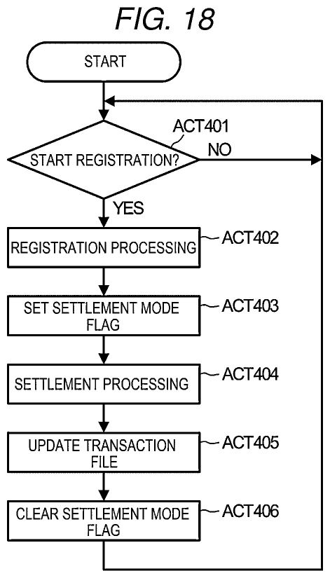

FIG. 18 is a flowchart illustrating a main part procedure of information processing executed by the processor 422 of the self-service POS terminal 40. For example, in response to power-on of the self-service POS terminal 40 or predetermined start operation by the touch panel 404 in a store clerk mode by the store clerk SP, the processor 422 executes this processing based on a control program stored in the ROM 423 or the HDD 425. Note that the procedure illustrated in FIG. 18 is an example. The procedure is not particularly limited if the same result can be obtained.

In ACT 401, the processor 422 determines whether to start registration. Specifically, the processor 422 determines presence or absence of start operation on the touch panel 404 by the customer CS. Alternatively, the processor 422 may acquire, with the LAN interface 426, via the LAN, a captured image from the camera 30 corresponding to the self-service POS terminal 40 and determine, according to whether the customer CS is detected in the customer detection area ROI1, whether to start registration. If the self-service POS terminal 40 includes a human sensor such as an infrared sensor or an ultrasonic sensor, the processor 422 can also make the determination according to presence or absence of human detection by an image such as an infrared image or an ultrasonic image captured by the human detection sensor. The infrared sensor and the ultrasonic sensor are examples of an image sensor. If not to start registration, the processor 422 determines NO in ACT 401 and repeats ACT 401. In this way, the processor 422 waits for the start of registration. If starting registration, the processor 422 determines YES in ACT 401 and proceeds to ACT 402.

In ACT 402, the processor 422 executes registration processing. The customer CS takes out a purchase commodity from the commodity basket BK1 placed on the basket table 405, causes the scanner 413 to read a code symbol of the commodity, and thereafter puts the commodity in the commodity bag BG such as a register bag or a reusable shopping bag set on the scale unit 402. Accordingly, the processor 422 reads the code symbol from the commodity with the scanner 413, reads commodity information corresponding to a commodity code indicated by the read code symbol from the commodity master 4251, and registers the commodity information in the registration information 4241. If all purchase commodities were registered, the customer CS carries out predetermined input operation such as “proceed to checkout” button operation for instructing settlement displayed on the display 412 of the touch panel 404. Accordingly, the self-service POS terminal 40 ends the registration processing.

In ACT 403, the processor 422 sets, in the RAM 424, the settlement mode flag 4242 indicating that settlement processing is being carried out. For example, the processor 422 sets a value of the settlement mode flag 4242 stored in the RAM 424 to “1”.

In ACT 404, the processor 422 executes the settlement processing. In the settlement processing, the processor 424 causes the display 412 to display settlement guidance according to the registration information 4241, receives settlement by the customer CS with the depositing and dispensing device 428 and the card reader 430, and, if the settlement ends, dispenses a receipt with the printer 429.

After the end of the settlement processing, in ACT 405, the processor 422 updates the transaction file 4252 with the registration information 4241 for which the settlement ended. That is, the processor 422 additionally records a log of the current transaction in the transaction file 4252.

In ACT 406, the processor 422 clears the settlement mode flag 4242 set in the RAM 424. For example, the processor 422 sets the value of the settlement mode flag 4242 stored in the RAM 424 to “0”. Thereafter, the processor 422 proceeds to ACT 201.

A main part procedure of fraud detection processing executed by the processor 422 of the self-service POS terminal 40 is the same as the main part procedure explained with reference to FIG. 9 in the first embodiment. The settlement apparatus 20 and the processor 201 explained with reference to FIG. 9 only have to be replaced with the self-service POS terminal 40 and the processor 422 and the registration information only has to be replaced with the registration information 4241 stored in the RAM 424. Therefore, explanation of the main part procedure is omitted here. Note that, in this embodiment, since the customer CS does not move, it goes without saying that the specified period may be short.

As explained above, the processor 422 of the self-service POS terminal 40 to which the fraud detection apparatus according to the third embodiment is applied can operate in the same manner as the processor 201 of the settlement apparatus 20 in the first embodiment.

Accordingly, with the fraud detection apparatus according to the third embodiment, even if a fraud detection target is the self-service POS terminal 40, it is possible to achieve the same effects as the effects in the first embodiment.

### Fourth Embodiment

Next, a fourth embodiment is explained. Note that the same components and operations as the components and the operations in the first embodiment are denoted by the same reference numerals and signs as the reference numerals and signs in the first embodiment to omit explanation of the components and the operations.

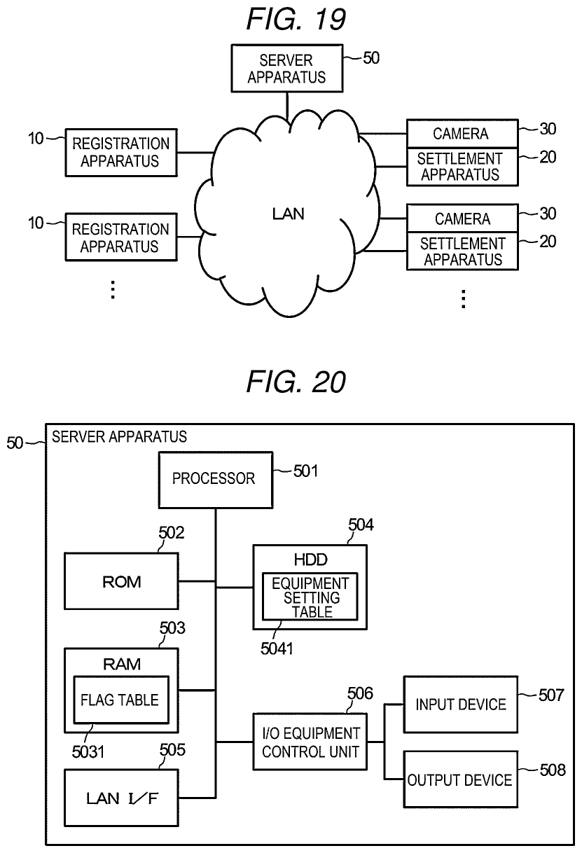

This embodiment is an example in which a fraud detection apparatus is provided separately from the settlement apparatus 20 that is a target apparatus that is a fraud detection target. FIG. 19 is a block configuration diagram of a semi-self-service checkout system to which a fraud detection system including the fraud detection apparatus according to the fourth embodiment is applied. In the checkout system, the plurality of registration apparatuses 10, the plurality of settlement apparatuses 20, the plurality of cameras 30, and a server apparatus 50 to which the fraud detection apparatus according to the fourth embodiment is applied are connected via a LAN.

FIG. 20 is a block diagram illustrating a main part configuration of the server apparatus 50 to which the fraud detection apparatus according to the fourth embodiment is applied, that is, in which the fraud detection apparatus is incorporated. As illustrated in FIG. 20, the server apparatus 50 includes a processor 501, a ROM 502, a RAM 503, a HDD 504, a LAN interface 505, an I/O equipment control unit 506, an input device 507, and an output device 508. The processor 501 and a memory including the ROM 502 and the RAM 503 are connected, whereby a computer of the server apparatus 50 is configured.

The processor 501 is equivalent to a central part of the computer. The processor 501 controls the units according to an operating system or a control program in order to implement various functions of the server apparatus 50 and the fraud detection apparatus according to this embodiment. The processor 501 may be, for example, a CPU, an MPU, an SoC, a DSP, a GPU, an ASIC, a PLD, or an FPGA. Alternatively, the processor 501 may be a combination of a plurality of devices among these devices.

The ROM 502 and the RAM 503 are equivalent to a main storage part of the computer. The ROM 502 stores the operating system or the control program. The RAM 503 stores data necessary for the processor 501 in executing processing for controlling the units. As one of the data, the RAM 503 stores a flag table 5031. The RAM 503 is used as a work area where data is rewritten as appropriate by the processor 501.

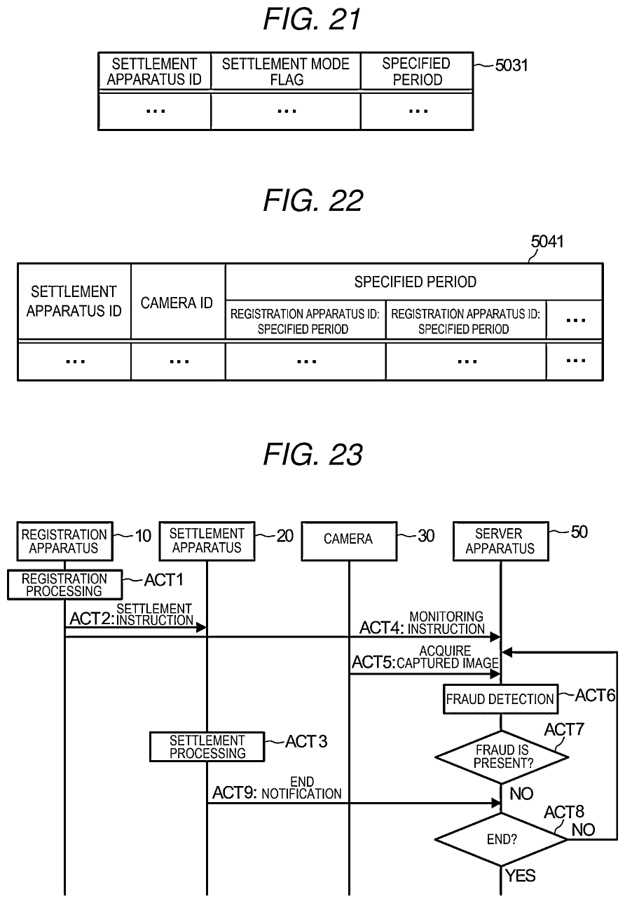

FIG. 21 is a diagram illustrating a data configuration of the flag table 5031 included in the RAM 503 of the server apparatus 50. As illustrated in FIG. 21, the flag table 5031 stores, for each of the plurality of settlement apparatuses 20, a settlement mode flag and a registration apparatus ID in association with a settlement apparatus ID that is an apparatus number or the like for uniquely identifying the settlement apparatus 20. The settlement mode flag corresponds to the settlement mode flag 2031 in the first embodiment. That is, the server apparatus 50 stores the settlement mode flag for each of the settlement apparatuses 20 in order to individually execute fraud detection for each of the plurality of settlement apparatuses 20. The registration apparatus ID is an apparatus number or the like for uniquely identifying the registration apparatus 10 at a generation source of registration information for which settlement is performed by the settlement apparatus 20 indicated by the settlement apparatus ID.

The HDD 504 stores various control programs. The control programs can include a fraud detection program for causing the server apparatus 50 to operate as the fraud detection apparatus according to the embodiment. The HDD 504 stores an equipment setting table 5041. Note that the server apparatus 50 may include a rewritable storage device such as an EEPROM or an SSD instead of or in addition to the HDD 504.

FIG. 22 is a diagram illustrating a data configuration of the equipment setting table 5041 included in the HDD 504 of the server apparatus 50. As illustrated in FIG. 22, the equipment setting table 5041 stores a camera ID and a specified period in association with a settlement apparatus ID of each of the plurality of settlement apparatuses 20. The camera ID is an apparatus number or the like of the camera 30 corresponding to the settlement apparatus 20. The specified period is a period set based on the distance from the registration apparatus 10 to the settlement apparatus 20 and includes a plurality of periods to correspond to each of the plurality of registration apparatuses 10. That is, the equipment setting table 5041 stores a specified period associated with a registration apparatus ID that is an apparatus number or the like for uniquely identifying each of the plurality of registration apparatuses 10. The settlement apparatus ID stored in the equipment setting table 5041 is read by the processor 501 at the start time of the server apparatus 50 and set in the flag table 5031 of the RAM 503.

The LAN interface 505 is a communication device for communicating with the registration apparatus 10, the settlement apparatus 20, and the camera 30 via the LAN.

The I/O equipment control unit 506 controls control information transmission from the processor 501 to the input device 507 and the output device 508 and data transmission in the opposite direction from the input device 507 and the output device 508 to the processor 501.

The input device 507 is a user interface device such as a keyboard or a pointing device such as a mouse. The output device 508 is a user interface device such as a liquid crystal display. Note that the server apparatus 50 may not include the input device 507 and/or the output device 508. That is, the input device 507 and/or the output device 508 can be provided on the outside of the server apparatus 50 as a management terminal or the like connected to the LAN. In this case, the processor 501 is capable of using the input device 507 and/or the output device 508 with the LAN interface 505 through the LAN.

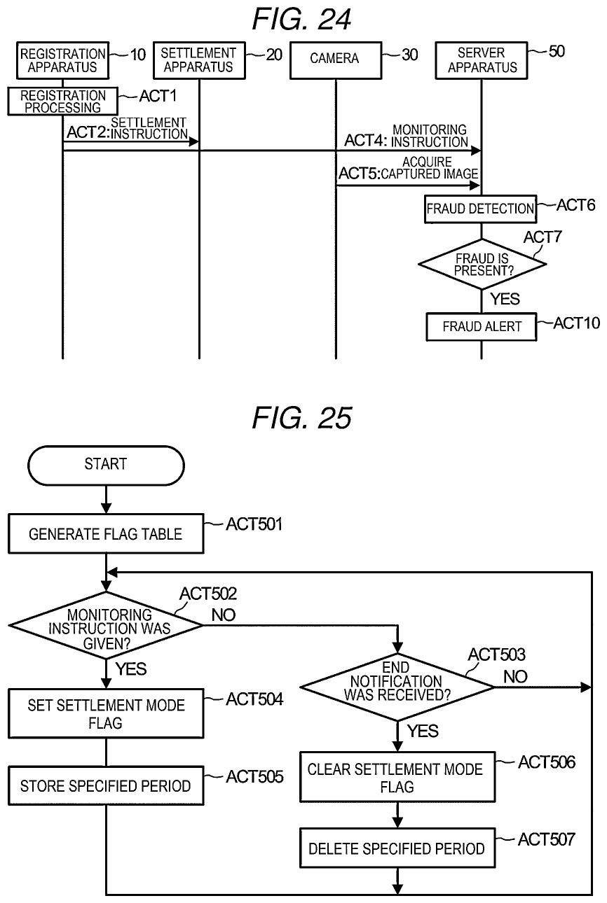

FIGS. 23 and 24 are sequence charts illustrating operation overviews of the fraud detection system. FIG. 23 illustrates a case in which a fraud is absent and FIG. 24 illustrates a case in which a fraud is present.

As illustrated in FIG. 23, if registration processing is performed in the registration apparatus 10 (ACT 1), a settlement instruction is transmitted from the registration apparatus 10 to the settlement apparatus 20 (ACT 2). The settlement instruction includes, for example, registration information. If receiving the settlement instruction, the settlement apparatus 20 executes settlement processing for receiving settlement by the customer CS (ACT 3).

In parallel to the above, the registration apparatus 10 transmits a monitoring instruction to the server apparatus 50 (ACT 4). The monitoring instruction includes, for example, a monitoring apparatus ID for specifying the registration apparatus 10 at a transmission source and a settlement apparatus ID for specifying the settlement apparatus 20 to be monitored. The server apparatus 50 receiving the monitoring instruction acquires a captured image from the camera 30 having a camera ID corresponding to the settlement apparatus 20 indicated by the settlement apparatus ID (ACT 5). The server apparatus 50 executes fraud detection based on the captured image (ACT 6) and determines presence or absence of a fraud (ACT 7). If a fraud is absent, the server apparatus 50 determines whether settlement in the monitoring target settlement apparatus 20 ended (ACT 8). If the settlement did not end yet, the server apparatus 50 repeats the processing from ACT 5.

If the settlement processing ends, the settlement apparatus 20 transmits an end notification to the server apparatus 50 (ACT 9). The end notification includes a settlement apparatus ID for specifying the settlement apparatus 20. If receiving the end notification, the server apparatus 50 can discriminate, with the settlement apparatus ID, in which settlement apparatus 20 the settlement processing ended. Therefore, the server apparatus 50 determines to end the fraud detection in ACT 8 and ends the fraud detection for the settlement apparatus 20.

In contrast, if a fraudulent act of going out to the outside of a store while holding an unsettled commodity occurred, as illustrated in FIG. 24, the server apparatus 50 detects that a fraud occurred (ACT 7) and carries out a fraud alert with the output device 508 (ACT 10).

Next, a specific example of an operation of the fraud detection apparatus applied to the server apparatus 50 is explained. FIG. 25 is a flowchart illustrating a main part procedure of information processing relating to settlement executed by the processor 501 of the server apparatus 50. For example, in response to power-on of the server apparatus 50, the processor 501 executes the processing based on the control program stored in the ROM 502 or the HDD 504. Note that the procedure illustrated in FIG. 25 is an example. The procedure is not particularly limited if the same result can be obtained.

In ACT 501, the processor 501 generates the flag table 5031. Specifically, the processor 501 reads settlement apparatus IDs from the equipment setting table 5041 stored in the HDD 504 and creates, in the RAM 503, the flag table 5031 having the read settlement apparatus IDs.

In ACT 502, the processor 501 determines whether a monitoring instruction was given. Specifically, the processor 501 determines whether the monitoring instruction was received by the LAN interface 505, via the LAN, from any one of the registration apparatuses 10 having the settlement apparatus IDs set in the flag table 5031. If the monitoring instruction was given, the processor 501 determines YES in ACT 502 and proceeds to ACT 504. If the monitoring instruction was not given, the processor 501 determines NO in ACT 502 and proceeds to ACT 503.

In ACT 503, the processor 501 determines whether an end notification was received. Specifically, the processor 501 determines whether the end notification was received by the LAN interface 505, via the LAN, from any one of the registration apparatuses 10 having the settlement apparatus IDs set in the flag table 5031. If receiving the end notification, the processor 501 determines YES in ACT 503 and proceeds to ACT 506. If not receiving the end notification, the processor 501 determines NO in ACT 503 and proceeds to ACT 502.

As explained above, the processor 501 waits for the monitoring instruction or the end notification.

If the monitoring instruction was given, in ACT 504, the processor 501 sets a settlement mode flag corresponding to the monitoring instruction. Specifically, the processor 501 sets, based on the settlement apparatus ID included in the monitoring instruction, a settlement mode flag associated with the settlement apparatus ID of the flag table 5031. For example, the processor 501 sets a value of the settlement mode flag to “1”.

In ACT 505, the processor 501 stores a specified period. Specifically, the processor 501 reads a specified period from the equipment setting table 5041 of the HDD 504 based on the registration apparatus ID and the settlement apparatus ID included in the monitoring instruction and stores the read specified period in association with the settlement apparatus ID of the flag table 5031. Thereafter, the processor 501 proceeds to ACT 502.

If receiving the end notification, in ACT 506, the processor 501 clears a settlement mode flag corresponding to the end notification. Specifically, the processor 501 clears, based on the settlement apparatus ID included in the end notification, a settlement mode flag associated with the settlement apparatus ID of the flag table 5031. For example, the processor 501 sets a value of the settlement mode flag to “0”.

In ACT 507, the processor 501 deletes a specified period corresponding to the end notification. Specifically, the processor 501 deletes a specified period associated with the settlement apparatus ID of the flag table 5031. Thereafter, the processor 501 proceeds to ACT 502.

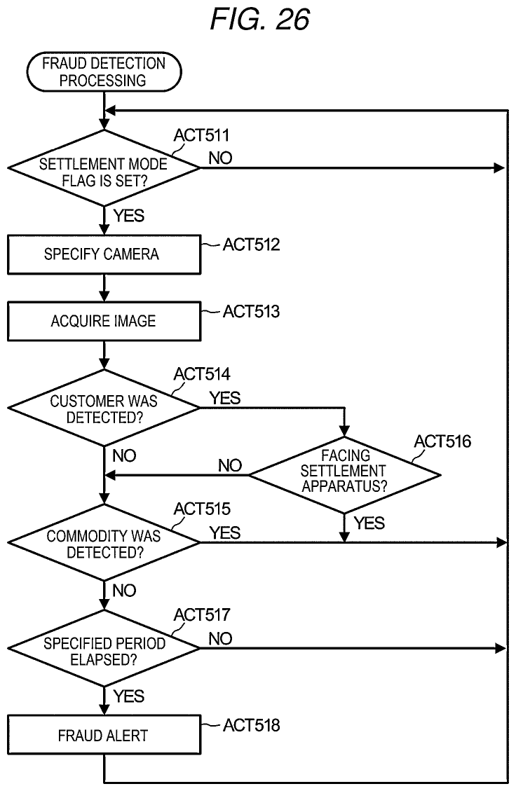

FIG. 26 is a flowchart illustrating a main part procedure of fraud detection processing executed by the processor 501 of the server apparatus 50. The fraud detection processing is processing of the fraud detection apparatus by the processor 501. For example, the processor 501 starts the fraud detection processing simultaneously with the start of the information processing relating to the settlement illustrated in FIG. 9. That is, the processor 501 executes the information processing relating to the settlement and the fraud detection processing in parallel.

In ACT 511, the processor 501 determines whether a settlement mode flag is set in the flag table 5031 of the RAM 503. That is, the processor 501 determines whether a settlement mode flag, a value of which is “1”, is present in the flag table 5031. If no settlement mode flag is set, the processor 501 determines NO in ACT 511 and repeats ACT 511. In this way, the processor 501 waits for any settlement mode flag in the flag table 5031 to be set, that is, waits for the start of settlement processing. If any settlement mode flag is set, the processor 501 determines YES in ACT 511 and proceeds to ACT 512. Note that processing in ACT 512 and subsequent acts is executed for each of the settlement apparatuses 20 having settlement apparatus IDs for which settlement mode flags are set. In other words, the processor 501 executes the processing in ACT 512 and subsequent acts in parallel on each of the settlement apparatuses 20 having the settlement apparatus IDs for which the settlement mode flags are set.

In ACT 512, the processor 501 specifies the camera 30 corresponding to the settlement apparatus 20 having the targe settlement apparatus ID. Specifically, the processor 501 reads a camera ID stored in association with the target settlement apparatus ID in the equipment setting table 5041 of the HDD 504.

In ACT 513, the processor 501 acquires a captured image from the specified camera 30. Specifically, the processor 501 acquires, with the LAN interface 505, a captured image of the camera 30 indicated by the camera ID out of the plurality of cameras 30 connected to the LAN.

In ACT 514, the processor 501 determines, based on the acquired captured image, whether the customer CS was detected. That is, the processor 501 determines whether a person is present or absent in the front of the target settlement apparatus 20. The processor 501 is an example of a person detecting unit that detects, based on the captured image PI captured by the camera 30, a person in a first area in the periphery of the settlement apparatus 20. If the customer CS was detected, the processor 501 determines YES in ACT 514 and proceeds to ACT 516. If the customer CS was not detected, the processor 501 determines NO in ACT 514 and proceeds to ACT 515.

In ACT 515, the processor 501 determines, based on the acquired captured image, whether a commodity was detected. The processor 501 is an example of a commodity detecting unit that detects at least one of a commodity and a storing body storing the commodity in a second area in the periphery of the settlement apparatus 20. If a commodity was detected, the processor 501 determines YES in ACT 515 and proceeds to ACT 511. If a commodity was not detected, the processor 501 determines NO in ACT 515 and proceeds to ACT 517.

In ACT 516, the processor 501 determines whether the customer CS is facing the target settlement apparatus 20. If the customer CS is facing the settlement apparatus 20, the processor 501 determines YES in ACT 516 and proceeds to ACT 511. If the customer CS is not facing the settlement apparatus 20, the processor 501 determines NO in ACT 516 and proceeds to ACT 515.

In ACT 517, the processor 501 determines whether a specified period elapsed after the settlement mode flag was set. If the specified period did not elapse, the processor 501 determines NO in ACT 517 and proceeds to ACT 511. If the specified period elapsed, the processor 501 determines YES in ACT 517 and proceeds to ACT 518.

Note that, if the settlement processing ended and the settlement mode flag was cleared in a loop of ACT 511 to ACT 517, it is determined NO in ACT 511. Therefore, the processing in ACT 512 to ACT 517 is ended. In other words, the processor 501 executes the operations of the person detecting unit, the commodity detecting unit, and the fraud alerting unit until the settlement processing in the settlement apparatus 20 ends.

In ACT 518, the processor 501 assumes that it is highly likely that a fraudulent act of taking out a registered commodity to the outside of the store without settling an account occurred and performs a fraud alert. The processor 501 is an example of a fraud alerting unit that alerts the store clerk SP to a fraud if the person detecting unit does not detect a person and the commodity detecting unit does not detect both of a commodity and a storing body in a state in which settlement processing by the customer CS is executed for the commodity. The fraud alert may be performed by, for example, the output device 508 or fraud information indicating that fraud occurrence is highly likely may be transmitted by the LAN interface 505, via the LAN, to the registration apparatus 10 that is a transmission source of the monitoring instruction. Rather than protecting an image of a registering customer not to be erased or storing the image as another file in the registration apparatus 10 as explained in the first embodiment, the server apparatus 50 may execute the protection or the storage. Thereafter, the processor 501 proceeds to ACT 511.

As explained above, the processor 501 of the server apparatus 50 to which the fraud detection apparatus according to the fourth embodiment is applied executes the operations of the person detection, the commodity detection, and the fraud alert until the settlement processing in the settlement apparatus 20 ends.

Accordingly, with the fraud detection apparatus according to the fourth embodiment, one server apparatus 50 can detect frauds in the respective plurality of settlement apparatuses 20 connected via the LAN.

Note that, in the fourth embodiment, as in the second embodiment, if input operation to the touch panel 211 in the settlement apparatus 20 was detected, the processor 501 may not carry out the fraud detection processing for a predetermined time. This can be easily implemented by notifying the input from the settlement apparatus 20 to the server apparatus 50 according to the input operation to the touch panel 211 and the processor 501 determining whether the notification was received.

It goes without saying that the fourth embodiment is also applicable to a full-self-service checkout system in which the self-service POS terminal 40 explained in the third embodiment is used. That is, the processor 501 of the server apparatus 50 to which the fraud detection apparatus according to the fourth embodiment is applied executes the operations of the person detection, the commodity detection, and the fraud alert in a period from when the registration processing ends until when the settlement processing ends in the self-service POS terminal 40.

Accordingly, with the fraud detection apparatus according to the fourth embodiment, one server apparatus 50 can detect frauds in the respective plurality of self-service POS terminals 40 connected via the LAN.

### Fifth Embodiment

Next, a fifth embodiment is explained. Note that the same components and operations as the components and the operations in the first embodiment are denoted by the same reference numerals and signs as the reference numerals and signs in the first embodiment to omit explanation of the components and the operations.

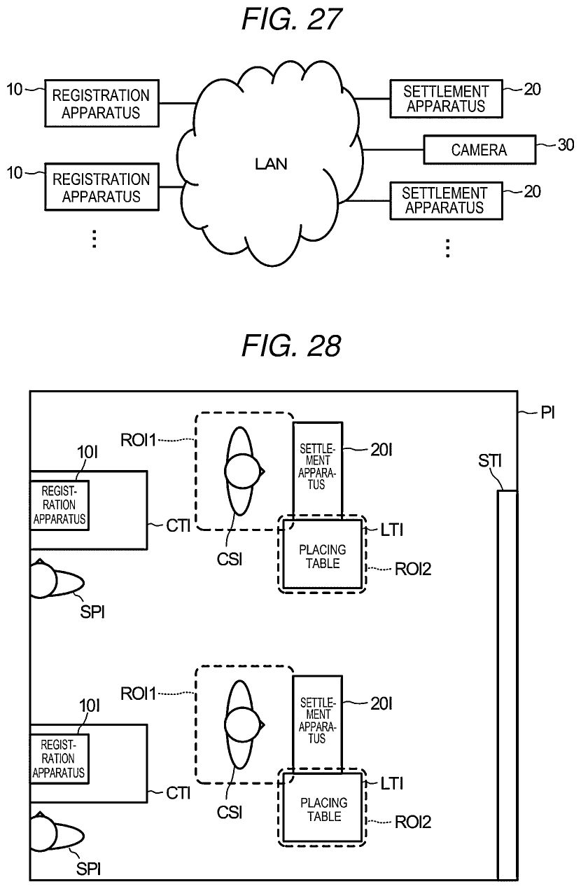

FIG. 27 is a block configuration diagram of a semi-self-service checkout system to which a fraud detection system according to the fifth embodiment is applied. In the first embodiment, the settlement apparatus 20 and the camera 30 are in a one-to-one relation. However, this embodiment is an example of a case in which one camera 30 images a plurality of, for example, two settlement apparatuses 20 as illustrated in FIG. 27. That is, the settlement apparatuses 20 and the camera 30 are in a two-to-one relation.

FIG. 28 is a schematic diagram for explaining a detection area in the captured image PI of the camera 30. Since the camera 30 is fixedly installed, a positional relation between the camera 30 and the two settlement apparatuses 20 and two placing tables LT does not change. Therefore, as illustrated in FIG. 28, the captured image PI always includes settlement apparatus images 201 that are images of the settlement apparatuses 20 and placing table images LT1 that are images of the placing tables LT. The captured image PI also includes parts of counter table images CTI that are images of counter tables CT, registration apparatus images 10I that are images of the registration apparatuses 10, and a sacker table image ST1 that is an image of the sacker table ST. In some cases, the captured image PI also includes customer images CSI that are images of customers CS and store clerk images SPI that are images of store clerks SP. The processor 201 sets, in the captured image PI, customer detection areas ROI1 and commodity detection areas ROI2 for the respective settlement apparatuses 20 and the respective placing tables LT, segments images of the respective detection areas, and detects customers or commodities from the segmented images. Two commodity detection areas ROI2 may be areas where commodity cart images SCI that are images of commodity carts SC in the captured image PI are also fit in the commodity detection areas ROI2. As explained above, the processor 201 segments, from the captured image PI captured by the one camera 30 that images the peripheries of the plurality of settlement apparatuses 20, an image of a first area and an image of a second area of the one settlement apparatus 20 for which the fraud detection apparatus should detect a fraud.

In this embodiment, information processing and fraud detection processing relating to settlement executed by processors 201 of the respective settlement apparatuses 20 are the same as the information processing and the fraud detection processing in the first embodiment explained with reference to FIGS. 8 and 9.

As explained above, the processor 201 of the settlement apparatus 20 to which the fraud detection apparatus according to the fifth embodiment is applied segments, from the captured image PI captured by the one camera 30 that images the peripheries of the plurality of settlement apparatuses 20, an image of the first area of the one settlement apparatus 20 for which the processor 201 should detect a fraud and detects a person.

Accordingly, with the fraud detection apparatus according to the fifth embodiment, as in the fraud detection apparatus according to the first embodiment, it is possible to detect a person by narrowing down the captured image PI captured by the camera 30 to an image of a specific area. Therefore, the processing can be increased in speed. Since the one camera 30 can be shared by a plurality of fraud detection apparatuses, it is possible to reduce costs of the fraud detection system.

The processor 201 of the settlement apparatus 20 to which the fraud detection apparatus according to the fifth embodiment is applied segments, from the captured image PI captured by the one camera 30 that images the peripheries of the plurality of settlement apparatuses 20, an image of the second area of the one settlement apparatus 20 for which the processor 201 should detect a fraud and detects a commodity or at least one of the commodity basket BK2 and the commodity cart SC that are the storing bodies.

Accordingly, with the fraud detection apparatus according to the fifth embodiment, as in the fraud detection apparatus according to the first embodiment, it is possible to detect a commodity, the commodity basket BK2, and the commodity cart SC by narrowing down the captured image PI captured by the camera 30 to an image of a specific area. Therefore, the processing can be increased in speed. Since the one camera 30 can be shared by the plurality of fraud detection apparatuses, it is possible to reduce costs of the fraud detection system.

Note that it goes without saying that the fifth embodiment is applicable to the second embodiment and the fourth embodiment as well.

The fraud detection systems and the fraud detection apparatuses according to the embodiments are explained above. However, embodiments are not limited to the embodiments explained above.

For example, in all the embodiments, as transmission destinations of the fraud alert, specific monitoring terminals such as a security guard terminal used by a security guard or the like and an attendant terminal used by an escort store clerk called attendant may be added.

As the correspondence relation between the settlement apparatus 20 or the self-service POS terminal 40 and the camera 30, the one-to-one relation and the two-to-one relation are explained as examples. However, the correspondence relation may be a many-to-one relation or may be, conversely, a one-to-many relation. For example, the customer CS and a commodity, the commodity basket BK2, and the commodity cart SC may be imaged by different cameras 30. The camera 30 is not limited to be installed above the apparatus. For example, the camera 30 for imaging a commodity, the commodity basket BK2, and the commodity cart SC is disposed above the apparatus and the camera 30 for imaging the customer CS is disposed to image the customer CS from the side of the touch panels 211 and 404 or from the lateral direction of the apparatus. If the camera 30 is disposed on the side of the touch panels 211 and 404 or in the lateral direction of the apparatus, “the direction of a person” may be set as “the direction of a face” or “the direction of a body” rather than being determined as “the direction of a face and a body” in the customer image CSI. If a security camera is installed on a ceiling in advance, the security camera may be used as the camera 30 disposed above rather than the camera 30 being installed as a dedicated camera.

In the detection of the customer CS and the detection of a commodity, a detection method not using the camera 30 can also be adopted. For example, in the detection of the customer CS, an image such as an infrared image or an ultrasonic image captured using an infrared sensor or an ultrasonic sensor can be used. In this case, the sensor is disposed to face the front of the apparatus and a detection area of the sensor is set as the customer detection area ROI1. The customer CS in the customer detection area ROI1 in the periphery of the apparatus can be detected according to whether a distance changed by a preset threshold or more from a state in which a person is absent in front of the apparatus. In the detection of a commodity, similarly, an infrared sensor or an ultrasonic sensor only has to be disposed to face upward from a placing surface of the placing table LT or disposed to face the front of the placing table LT and a detection area of the sensor only has to be set as the commodity detection area ROI2. Alternatively, since the self-service POS terminal 40 includes the scale unit 402, the bag holder 408 and the placing surface 409 of the scale unit 402 are set as the commodity detection area ROI2. A commodity can be detected according to whether a weight value changed by a threshold or more from a weight value at the time when the commodity is not placed on the scale unit 402. In the settlement apparatus 20, similarly, a commodity can be detected by making it possible to measure the weight of an object placed on the placing table LT.

The order of ACTS 213 and 215 and ACT 214 in the flowchart of FIG. 9 may be reversed. That is, the customer CS may be detected after a commodity is detected first. Similarly, the order of ACT 202 and ACT 203 in the flowchart of FIG. 8 may be reversed. Alternatively, ACT 202 and ACT 203 may be performed in parallel. As explained above, the order of processing may be changed and a plurality of kinds of processing may be performed in parallel unless a contradiction to the preceding or following processing occurs.

Note that, in the embodiments explained above, the control program executed by the processor 201 of the settlement apparatus 20, the processor 422 of the self-service POS terminal 40, or the processor 501 of the server apparatus 50 may be configured to be provided by being recorded in a non-transitory computer-readable recording medium such as a CD-ROM. The control program may be configured to be stored on a computer connected to a network such as the Internet and provided by being downloaded through the network.

Each function of the embodiments described above can be realized by one or more processing circuits. Here, the term “processing circuit” as used herein includes a processor programmed to execute each function by software, such as a processor implemented by an electronic circuit, or a device such as an ASIC (Application Specific Integrated Circuit), a DSP (Digital Signal Processor), a FPGA (Field Programmable Gate Array), and conventional circuit modules.

Besides, the several embodiments are explained above. However, these embodiments are presented as examples and are not intended to limit the scope of the invention. These new embodiments can be implemented in other various forms. Various omissions, substitutions, and changes can be made without departing from the gist of the invention. The embodiments and modifications thereof are included in the scope of the invention and included in the scope of the inventions described in the claims and equivalents of the inventions.

### Notes

Disclosures having configurations explained below can be extracted from the specific embodiments explained above.

[1]A fraud detection apparatus including:
a person detecting unit configured to detect, based on an image capturing a target apparatus that is a fraud detection target, a person in a first area in a periphery of the target apparatus;
a commodity detecting unit configured to detect, based on the image, at least one of a commodity and a storing body storing the commodity in a second area in the periphery of the target apparatus; and
a fraud alerting unit configured to alert a store clerk to a fraud if the person detecting unit does not detect the person and the commodity detecting unit does not detect both of the commodity and the storing body in a state in which settlement processing is executed for the commodity.

[2] The fraud detection apparatus described in [1], further including:
a person direction detecting unit configured to detect a direction of the person detected by the person detecting unit; and
a detection disabling unit configured to disable the detection of the person detecting unit if the direction of the person detected by the person direction detecting unit is not a direction of the target apparatus.

[3] The fraud detection apparatus described in [1] or [2], further including:
an input detecting unit configured to detect input operation to the target apparatus by the person; and
an alert suppressing unit configured to, if the input detecting unit detected the input operation, suppress alert processing of the fraud alerting unit for a predetermined time.

[4] The fraud detection apparatus described in [1], wherein the second area is an area including a placing section on which at least one of the commodity and the storing body is placed if the settlement processing is executed in the target apparatus.

[5] The fraud detection apparatus described in [1], wherein
the storing body includes at least one of a commodity basket that stores the commodity and a commodity cart that stores the shopping basket, and
the second area is an area including a placing section on which the commodity basket is placed if the settlement processing is executed in the target apparatus and a retaining section in a periphery of the placing section in which the commodity cart is retained.

[6] The fraud detection apparatus described in [1], wherein the person detecting unit detects the person based on a captured image of the first area captured by the camera.

[7] The fraud detection apparatus described in [6], wherein the person detecting unit segments an image of the first area from the captured image including the first area and the second area captured by the camera and detects the person.

[8] The fraud detection apparatus described in [6], wherein the person detecting unit segments, from the captured image captured by the camera that images peripheries of a plurality of the target apparatuses, an image of the first area of a singularity of the target apparatus for which the fraud detection apparatus should detect a fraud and detects the person.

[9] The fraud detection apparatus described in [1], wherein the commodity detecting unit detects at least one of the commodity and the storing body based on a captured image of the second area captured by a camera.

[10] The fraud detection apparatus described in [9], wherein the commodity detecting unit segments an image of the second area from the captured image including the first area and the second area captured by the camera and detects at least one of the commodity and the storing body.

[11] The fraud detection apparatus described in [9], wherein the commodity detecting unit segments, from the captured image captured by the camera that images peripheries of a plurality of the target apparatuses, an image of the second area of a singularity of the target apparatus for which the fraud detection apparatus should detect a fraud and detects the commodity or the storing body.

[12] The fraud detection apparatus described in [1], wherein
the target apparatus is a settlement apparatus that performs settlement processing for a purchase commodity registered by a registration apparatus, and
the fraud detection apparatus is incorporated in the settlement apparatus.

[13] The fraud detection apparatus described in [1], wherein
the target apparatus is a settlement apparatus that performs settlement processing for a purchase commodity registered by a registration apparatus, and
the fraud detection apparatus includes a server apparatus connected to the settlement apparatus, the server apparatus executing operations of the person detecting unit, the commodity detecting unit, and the fraud alerting unit until the settlement processing in the settlement apparatus ends.

[14] The fraud detection apparatus described in [1], wherein
the target apparatus is a registration and settlement apparatus that performs registration processing for registering a purchase commodity and settlement processing for the purchase commodity, and
the fraud detection apparatus is incorporated in the registration and settlement apparatus.

[15] The fraud detection apparatus described in [1], wherein
the target apparatus is a registration and settlement apparatus that performs registration processing for registering a purchase commodity and settlement processing for the purchase commodity as the specified processing, and
the fraud detection apparatus includes a server apparatus connected to the registration and settlement apparatus, the server apparatus executing operations of the person detecting unit, the commodity detecting unit, and the fraud alerting unit in a period from when the registration processing ends until when the settlement processing in the settlement apparatus ends in the registration and settlement apparatus.

[16]A fraud detection system including:
a plurality of target apparatuses that are fraud detection targets;
one image sensor configured to capture images of the plurality of target apparatuses; and
a fraud detection apparatus connected to the image sensor,
the fraud detection apparatus including:
   a person detecting unit configured to detect, based on an image of the image sensor capturing the plurality of target apparatuses, a person in a first area in a periphery of one target apparatus among the plurality of target apparatuses;
   a commodity detecting unit configured to detect, based on the image of the image sensor capturing the plurality of target apparatuses, at least one of a commodity and a storing body storing the commodity in a second area in the periphery of the one target apparatus among the plurality of target apparatuses; and
   a fraud alerting unit configured to alert a store clerk to a fraud if the person detecting unit does not detect the person and the commodity detecting unit does not detect both of the commodity and the storing body in a state in which the one target apparatus is executing settlement processing for the commodity.

[17]A fraud detection method including:
detecting, based on an image capturing a target apparatus that is a fraud detection target, a person in a first area in a periphery of the target apparatus;
detecting, based on the image, at least one of a commodity and a storing body storing the commodity in a second area in the periphery of the target apparatus; and
alerting a store clerk to a fraud if the person is not detected and both of the commodity and the storing body are not detected in a state in which settlement processing is executed for the commodity.

[18]A fraud detection apparatus including a processor and a memory,
the processor being configured to:
detect, based on an image capturing a target apparatus that is a fraud detection target, a person in a first area in a periphery of the target apparatus;
detect, based on the image, at least one of a commodity and a storing body storing the commodity in a second area in the periphery of the target apparatus; and
alert a store clerk to a fraud if the person is not detected and both of the commodity and the storing body are not detected in a state in which settlement processing is executed for the commodity.

What is claimed is:

1. A fraud detection apparatus, comprising:
a person detector configured to detect, based on an image capturing a target apparatus that is a fraud detection target, a person in a first area in a periphery of the target apparatus;
a commodity detector configured to detect, based on the image, at least one of a commodity and a storing body storing the commodity in a second area in the periphery of the target apparatus; and
a fraud alerting component configured to alert a store clerk to a fraud if the person detector does not detect the person and the commodity detector does not detect both of the commodity and the storing body in a state in which settlement processing is executed for the commodity.

2. The fraud detection apparatus according to claim 1, further comprising:
a person direction detector configured to detect a direction of the person detected by the person detector; and
a detection disabling component configured to disable the detection of the person detector if the direction of the person detected by the person direction detector is not a direction of the target apparatus.

3. The fraud detection apparatus according to claim 1, further comprising:
an input detector configured to detect input operation to the target apparatus by the person; and
an alert suppressing component configured to, if the input detector detects the input operation, suppress alert processing of the fraud alerting component for a predetermined time.

4. The fraud detection apparatus according to claim 1, wherein
the second area is an area including a placing section on which at least one of the commodity and the storing body is placed if the settlement processing is executed in the target apparatus.

5. The fraud detection apparatus according to claim 1, wherein
the storing body includes at least one of a commodity basket that stores the commodity and a commodity cart that stores the shopping basket, and
the second area is an area including a placing section on which the commodity basket is placed if the settlement processing is executed in the target apparatus and a retaining section in a periphery of the placing section in which the commodity cart is retained.

6. The fraud detection apparatus according to claim 1, further comprising:
a light emitting component that changes a light emission state to alert the store clerk.

7. The fraud detection apparatus according to claim 1, further comprising:
a display screen to display on a store clerk side of the fraud detection apparatus an alert the store clerk.

8. A fraud detection system, comprising:
a plurality of target apparatuses that are fraud detection targets;
one image sensor configured to capture images of the plurality of target apparatuses; and
a fraud detection apparatus connected to the image sensor,
the fraud detection apparatus including:
a person detector configured to detect, based on an image of the image sensor capturing the plurality of target apparatuses, a person in a first area in a periphery of one target apparatus among the plurality of target apparatuses;
a commodity detector configured to detect, based on the image of the image sensor capturing the plurality of target apparatuses, at least one of a commodity and a storing body storing the commodity in a second area in the periphery of the one target apparatus among the plurality of target apparatuses; and
a fraud alerting component configured to alert a store clerk to a fraud if the person detector does not detect the person and the commodity detector does not detect both of the commodity and the storing body in a state in which the one target apparatus is executing settlement processing for the commodity.

9. The fraud detection system according to claim 8, wherein the fraud detection apparatus further comprises:
a person direction detector configured to detect a direction of the person detected by the person detector; and
a detection disabling component configured to disable the detection of the person detector if the direction of the person detected by the person direction detector is not a direction of the target apparatus.

10. The fraud detection system according to claim 8, wherein the fraud detection apparatus further comprises:
an input detector configured to detect input operation to the target apparatus by the person; and
an alert suppressing component configured to, if the input detector detects the input operation, suppress alert processing of the fraud alerting component for a predetermined time.

11. The fraud detection system according to claim 8, wherein
the second area is an area including a placing section on which at least one of the commodity and the storing body is placed if the settlement processing is executed in the target apparatus.

12. The fraud detection system according to claim 8, wherein
the storing body includes at least one of a commodity basket that stores the commodity and a commodity cart that stores the shopping basket, and
the second area is an area including a placing section on which the commodity basket is placed if the settlement processing is executed in the target apparatus and a retaining section in a periphery of the placing section in which the commodity cart is retained.

13. The fraud detection system according to claim 8, further comprising:
a light emitting component that changes a light emission state to alert the store clerk.

14. The fraud detection system according to claim 8, further comprising:
a display screen to display on a store clerk side of the fraud detection apparatus an alert the store clerk.

15. A fraud detection method, comprising:
detecting, based on an image capturing a target apparatus that is a fraud detection target, a person in a first area in a periphery of the target apparatus;
detecting, based on the image, at least one of a commodity and a storing body storing the commodity in a second area in the periphery of the target apparatus; and
alerting a store clerk to a fraud if the person is not detected and both of the commodity and the storing body are not detected in a state in which settlement processing is executed for the commodity.

16. The fraud detection method according to claim 15, further comprising:
detecting a direction of the person detected; and
disabling the detection of the person if the direction of the person detected is not a direction of the target apparatus.

17. The fraud detection method according to claim 15, further comprising:
detecting input operation to the target apparatus by the person; and
if detecting the input operation, suppressing alert processing of the fraud alerting component for a predetermined time.

18. The fraud detection method according to claim 15, wherein
the second area is an area including a placing section on which at least one of the commodity and the storing body is placed if the settlement processing is executed in the target apparatus.

19. The fraud detection method according to claim 15, wherein
the storing body includes at least one of a commodity basket that stores the commodity and a commodity cart that stores the shopping basket, and
the second area is an area including a placing section on which the commodity basket is placed if the settlement processing is executed in the target apparatus and a retaining section in a periphery of the placing section in which the commodity cart is retained.

20. The fraud detection method according to claim 15, further comprising at least one of:
changing a light emission state a light emitting component to alert the store clerk; and
displaying on a store clerk side of a display screen an alert the store clerk.
